(19) United States
(12) Patent Application Publication
(10) Pub. No.: US 2026/0063958 A1
(43) Pub. Date: Mar. 5, 2026

(54) ELECTRO-OPTICAL DEVICE AND ELECTRONIC INSTRUMENT

(71) Applicant: SEIKO EPSON CORPORATION, Tokyo (JP)

(72) Inventor: Yuki GOTO, CHITOSE-SHI (JP)

(73) Assignee: SEIKO EPSON CORPORATION, Tokyo (JP)

(21) Appl. No.: 19/313,851

(22) Filed: Aug. 28, 2025

(30) Foreign Application Priority Data
Aug. 30, 2024 (JP) 2024-148494

(51) Int. Cl. G02F 1/1368; G02F 1/1362; G03B 21/00

(52) U.S. Cl. CPC G02F 1/1368; G02F 1/13629; G03B 21/006

(57) ABSTRACT

An electro-optical device includes: a first transistor of a first electrical conductivity type; a second transistor of a second electrical conductivity type; a first source-drain electrode electrically coupled to a first source-drain region of the first transistor; a second source-drain electrode electrically coupled to a second source-drain region of the second transistor; a first scan line disposed in a first layer between the first transistor and the first source-drain electrode, and electrically coupled to a first gate electrode of the first transistor; and a second scan line disposed in a second layer on a side opposite the second transistor with the second source-drain electrode interposed therebetween, and electrically coupled to a second gate electrode of the second transistor.

The present application is based on, and claims priority from JP Application Serial Number 2024-148494, filed Aug. 30, 2024, the disclosure of which is hereby incorporated by reference herein in its entirety.

### BACKGROUND

### 1. Technical Field

The present disclosure relates to an electro-optical device and an electronic instrument.

### 2. Related Art

A liquid crystal display device including transistors is known. The liquid crystal display device is an example of an electro-optical device. The liquid crystal display device described in JP-A-9-189922 includes data lines, gate lines, and thin film transistors for pixels. The data lines and the gate lines are perpendicular to each other. Pixel regions are formed at positions corresponding to the intersections of the data lines and the gate lines. A liquid crystal cell is formed in each of the pixel regions, and an image signal is input to the liquid crystal cell via the thin film transistors. The thin film transistors include an N-type thin film transistor and a P-type thin film transistor. The gate lines for each of the pixel regions are configured with a first gate line and a second gate line. The first gate line is coupled to the N-type thin film transistor. The second gate line is coupled to the P-type thin film transistor. The first gate line and the second gate line are disposed in the same plane of the liquid crystal display device.

JP-A-9-189922 is an example of the related art.

In the configuration of the related art, it is difficult to reduce the influence of parasitic capacitance generated between the lines wired to the transistors.

### SUMMARY

An electro-optical device according to an aspect of the present disclosure includes: a first transistor of a first electrical conductivity type; a second transistor of a second electrical conductivity type; a first source-drain electrode electrically coupled to a first source-drain region of the first transistor; a second source-drain electrode electrically coupled to a second source-drain region of the second transistor; a first scan line disposed in a first layer between the first transistor and the first source-drain electrode, and electrically coupled to a first gate electrode of the first transistor; and a second scan line disposed in a second layer on a side opposite the second transistor with the second source-drain electrode interposed therebetween, and electrically coupled to a second gate electrode of the second transistor.

An electronic instrument according to another aspect of the present disclosure includes the electro-optical device described above.

### BRIEF DESCRIPTION OF THE DRAWINGS

FIG. 1 shows a schematic configuration of a liquid crystal device.

FIG. 2 diagrammatically shows the configuration of the liquid crystal device.

FIG. 3 shows an electrical configuration of an element substrate.

FIG. 4 shows a schematic configuration of a first element substrate.

FIG. 5 shows another schematic configuration of the first element substrate.

FIG. 6 shows another schematic configuration of the first element substrate.

FIG. 7 shows another schematic configuration of the first element substrate.

FIG. 8 shows another schematic configuration of the first element substrate.

FIG. 9 shows the process of creating the first element substrate.

FIG. 10 shows the process of creating the first element substrate.

FIG. 11 shows the process of creating the first element substrate.

FIG. 12 shows the process of creating the first element substrate.

FIG. 13 shows the process of creating the first element substrate.

FIG. 14 shows the process of creating the first element substrate.

FIG. 15 shows the process of creating the first element substrate.

FIG. 16 shows the process of creating the first element substrate.

FIG. 17 shows a schematic configuration of a second element substrate.

FIG. 18 shows a schematic configuration of the second element substrate.

FIG. 19 shows a schematic configuration of the second element substrate.

FIG. 20 shows the process of creating a second element substrate.

FIG. 21 shows the process of creating the second element substrate.

FIG. 22 shows the process of creating the second element substrate.

FIG. 23 shows the process of creating the second element substrate.

FIG. 24 shows the process of creating the second element substrate.

FIG. 25 shows the process of creating the second element substrate.

FIG. 26 shows a schematic configuration of a projection-type display apparatus.

### DESCRIPTION OF EMBODIMENTS

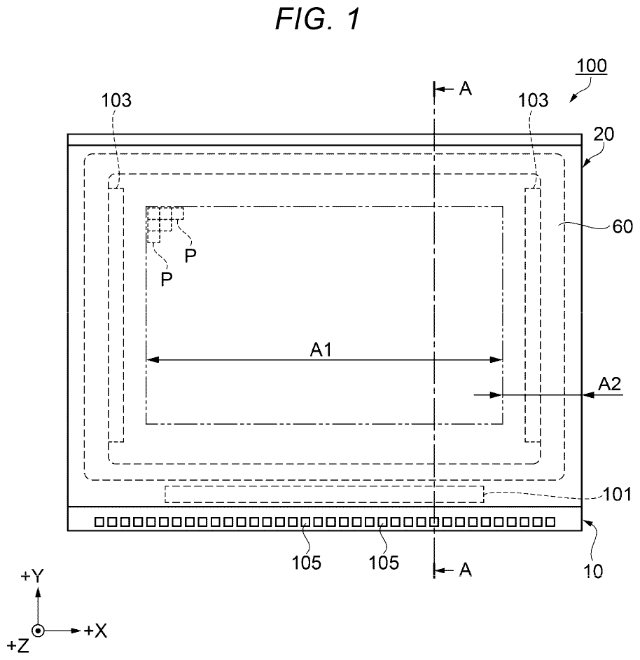

FIG. 1 shows a schematic configuration of a liquid crystal device 100. The liquid crystal device 100 corresponds to an example of an electro-optical device. The liquid crystal device 100 is a transmissive liquid crystal device driven in an active matrix mode and including a thin film transistor (TFT) as a switching element for each pixel P. FIG. 1 is a plan view of the liquid crystal device 100. The liquid crystal device 100 includes an element substrate 10, a counter substrate 20, and a sealing member 60. The liquid crystal device 100 has a display region A1 and a peripheral region A2.

In multiple drawings including FIG. 1, the dimensions of each element differ from the actual dimensions in some cases to facilitate understanding of the element. The dimensional ratio of each element in the drawings differs from the actual dimensional ratio of the element.

Multiple drawings including FIG. 1 show an XYZ coordinate system. The X direction, the Y direction, and the Z direction are directions orthogonal to each other. The Z direction is a direction parallel to the direction in which the element substrate 10 and the counter substrate 20 are layered on each other. A +Z direction is the direction from the element substrate 10 toward the counter substrate 20. A −Z direction is the direction from the counter substrate 20 toward the element substrate 10. The X direction is a direction parallel to the direction in which external coupling terminals 105 are arranged. A +X direction is the direction from left to right in FIG. 1. A −X direction is the direction from right to left in FIG. 1. The Y direction is the direction perpendicular to the X direction and the Z direction. A +Y direction is the direction from below to above in FIG. 1. A −Y direction is the direction from above to below in FIG. 1.

The element substrate 10 is disposed on the light exiting side of a liquid crystal layer 50. The element substrate 10 is configured with a light transmissive member. The term “light transmissive” indicates transmitting part of visible light. The term “light transmissive” preferably indicates that the transmittance for visible light is 50% or higher. The element substrate 10 has a substantially rectangular shape in a plan view viewed in the +Z direction. The element substrate 10 is bonded to the counter substrate 20 via the sealing member 60. The element substrate 10 is configured to be larger than the counter substrate 20 in the plan view viewed in the +Z direction. The element substrate 10 includes a data line driving circuit 101, scan line driving circuits 103, an inspection circuit that is not shown, and multiple external coupling terminals 105.

The data line driving is circuit 101 electrically coupled to multiple data lines 5, which will be described later. The data line driving circuit 101 supplies an image signal to each of the multiple data lines 5.

The scan line driving circuits 103 are electrically coupled to multiple scan lines 3, which will be described later. The scan line driving circuits 103 supply a scan signal to each of the multiple scan lines 3.

The inspection circuit is electrically coupled to the multiple data lines 5. The inspection circuit supplies an inspection signal to each of the multiple data lines 5.

The external coupling terminals 105 are mount terminals on which external coupling lines such as a flexible printed circuit (FPC) that is not shown are mounted. Various signals such as the image signal, a synchronization signal, the inspection signal, common potential, and power supply potential are externally supplied to the external coupling terminals 105 via the external coupling lines. The external coupling terminals 105 are provided in a region of the element substrate 10 that does not overlap with the counter substrate 20.

The counter substrate 20 is disposed on the light incident side of the liquid crystal layer 50. The counter substrate 20 has a substantially rectangular shape in the plan view viewed in the +Z direction. The counter substrate 20 is configured with a light transmissive member. The counter substrate 20 is bonded to the element substrate 10 via the sealing member 60.

The sealing member 60 is a frame-shaped member that surrounds the display region A1. The sealing member 60 is disposed between the element substrate 10 and the counter substrate 20. The sealing member 60 is made of an adhesive containing a curable resin such as an epoxy resin.

The display region A1 is provided in a region inside the sealing member 60. The display region A1 is a pixel region including multiple pixels P. The multiple pixels P are arranged in a matrix along the X direction and the Y direction.

The peripheral region A2 is provided in a region outside the display region A1. The peripheral region A2 has a rectangular shape that surrounds the display region A1. The sealing member 60, the data line driving circuit 101, the scan line driving circuits 103, and the like are provided in the peripheral region A2. Dummy pixels that do not contribute to display operation may be disposed in the peripheral region A2.

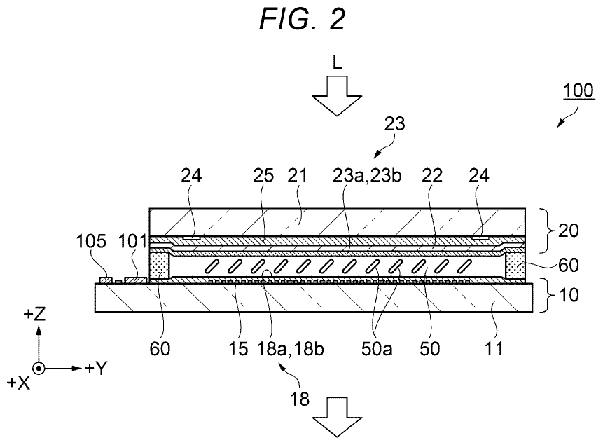

FIG. 2 diagrammatically shows the configuration of the liquid crystal device 100. FIG. 2 shows a cross section taken along the YZ plane including the line segment A-A in FIG. 1. FIG. 2 shows liquid crystal substances 50a contained in the liquid crystal layer 50 with the size and the number thereof different from the actual values.

The liquid crystal device 100 shown in FIG. 2 is a transmissive liquid crystal device. Incident light L is incident via a surface of the counter substrate 20 that is the surface facing the positive end in the Z direction. The incident light L passes through the liquid crystal layer 50 and exits via a surface of the element substrate 10 that is the surface facing the negative end in the Z direction. The incident light L is modulated in accordance with the orientation state of the liquid crystal substances 50a when passing through the liquid crystal layer 50. The surface on which the incident light L is incident is not limited to a surface of the counter substrate 20 that is the surface facing the positive end in the Z direction. The surface on which the incident light L is incident may be a surface of the element substrate 10 that is the surface facing the negative end in the Z direction. The liquid crystal device 100 is not limited to a transmissive liquid crystal device. The liquid crystal device 100 may be a reflective liquid crystal device. The liquid crystal device 100 is optically designed based on a normally white mode or a normally black mode. The liquid crystal device 100 may include a polarizer.

The element substrate 10 and the counter substrate 20 are disposed so as to face each other via the sealing member 60. The liquid crystal layer 50 is disposed between the element substrate 10 and the counter substrate 20. The liquid crystal layer 50 is disposed at a position where the liquid crystal layer 50 is surrounded by the element substrate 10, the counter substrate 20, and the sealing member 60.

The liquid crystal layer 50 contains the liquid crystal substances 50a. The liquid crystal substances 50a have positive or negative dielectric anisotropy. The liquid crystal substances 50a shown in FIG. 2 have negative dielectric anisotropy by way of example. The liquid crystal substances 50a are individual liquid crystal molecules or an aggregate of individual liquid crystal molecules.

The element substrate 10 includes an element substrate base 11, pixel electrodes 15, and a first orientation film 18. The element substrate base 11, the pixel electrodes 15, and the first orientation film 18 are arranged in the order of the element substrate base 11, the pixel electrodes 15, and the first orientation film 18 in the direction toward the liquid crystal layer 50.

The element substrate base 11 is a light transmissive, insulating planar plate. The element substrate base 11 is configured with a glass substrate or a quartz substrate. The element substrate base 11 is disposed on the light exiting side of the liquid crystal layer 50, via which the light having passed through the liquid crystal layer 50 exits.

The pixel electrodes 15 are provided in the display region A1. The pixel electrodes 15 are light transmissive electrodes. The pixel electrodes 15 are made, for example, of indium tin oxide (ITO). The pixel electrodes 15 may be made, for example, of a transparent, electrically conductive material such as indium zinc oxide (IZO) and fluorine-doped tin oxide (FTO).

The first orientation film 18 orients the liquid crystal substances 50a to a specific direction. The first orientation film 18 is formed based on the optical design of the liquid crystal device 100. The first orientation film 18 is disposed at a position where the first orientation film 18 is in contact with the sealing member 60. The first orientation film 18 has a region in contact with a surface of the sealing member 60 that is the surface facing the negative end in the Z direction, and a region facing the liquid crystal layer 50. The first orientation film 18 is disposed between the multiple pixel electrodes 15 and the liquid crystal layer 50. The first orientation film 18 includes a first evaporated film 18a and a second evaporated film 18b.

The first evaporated film 18a is formed by vacuum evaporation from above a surface of the element substrate 10 that is the surface facing the positive end in the Z direction. The first evaporated film 18a includes multiple columns each having a major axis along the Z direction. The first evaporated film 18a is made of silicon oxide, aluminum oxide, magnesium oxide, or the like.

The second evaporated film 18b is formed on the first evaporated film 18a. The thickness of the second evaporated film 18b along the Z direction is smaller than the thickness of the first evaporated film 18a along the Z direction. The second evaporated film 18b includes multiple columns each having a major axis that intersects with the Z direction at a predetermined angle. The columns in the second evaporated film 18b are each a columnar crystal of silicon oxide. The columns in the second evaporated film 18b are formed by oblique evaporation in a vacuum evaporation process.

The counter substrate 20 includes a counter substrate base 21, a partition 24, an insulating layer 25, a common electrode 22, and a second orientation film 23. The counter substrate base 21, the partition 24, the insulating layer 25, the common electrode 22, and the second orientation film 23 are arranged in the order of the counter substrate base 21, the partition 24, the insulating layer 25, the common electrode 22, and the second orientation film 23 in the direction toward the liquid crystal layer 50.

The counter substrate base 21 is a light transmissive, insulating planar plate. The counter substrate base 21 is disposed on the light incident side on which the incident light L is incident. The counter substrate base 21 is configured with a glass substrate or a quartz substrate. The counter substrate base 21 is made, for example, of silicon oxide (SiO₂) having a refractive index of 1.48.

The partition 24 is configured with a light blocking metal film or the like. The partition 24 is disposed at a position shifted in the +Z direction from the common electrode 22.

The insulating layer 25 is a light transmissive, insulating layer. The insulating layer 25 is made of an inorganic material such as silicon oxide. The insulating layer 25 may function as an optical path adjustment layer that adjusts the optical path of the incident light L.

The common electrode 22 is disposed so as to face the multiple pixel electrodes 15. The common electrode 22 is made of ITO. The common electrode 22 may be made of a transparent electrically conductive material such as IZO and FTO. The common electrode 22 and the pixel electrodes 15 apply an electric field to the liquid crystal layer 50. The common electrode 22 is electrically coupled to any of the multiple external coupling terminals 105 provided at the element substrate 10. Common electrode potential is applied to the common electrode 22 via the external coupling terminal 105. The common electrode potential is, for example, 6.5V.

The second orientation film 23 orients the liquid crystal substances 50a to a specific direction. The second orientation film 23 is formed based on the optical design of the liquid crystal device 100. The second orientation film 23 is disposed at a position where the second orientation film 23 is in contact with the sealing member 60. The second orientation film 23 has a region in contact with a surface of the sealing member 60 that is the surface facing the positive end in the Z direction, and a region facing the liquid crystal layer 50. The second orientation film 23 is disposed between the common electrode 22 and the liquid crystal layer 50. The second orientation film 23 includes a third evaporated film 23a and a fourth evaporated film 23b.

The third evaporated film 23a is formed by performing vacuum evaporation on a surface of the counter substrate 20 that is the surface facing the negative end in the Z direction. The third evaporated film 23a includes multiple columns each having a major axis along the Z direction. The third evaporated film 23a is made of silicon oxide, aluminum oxide, magnesium oxide, or the like.

The fourth evaporated film 23b is formed on the third evaporated film 23a. The thickness of the fourth evaporated film 23b along the Z direction is smaller than the thickness of the third evaporated film 23a along the Z direction. The fourth evaporated film 23b includes multiple columns each having a major axis that intersects with the Z direction at a predetermined angle. The columns of the fourth evaporated film 23b are each a columnar crystal of silicon oxide. The columns in the fourth evaporated film 23b are formed by oblique evaporation in a vacuum evaporation process.

The first orientation film 18 and the second orientation film 23 orient the liquid crystal substances 50a having negative dielectric anisotropy to a substantially vertical direction. The substantially vertical orientation indicates an orientation state in which the liquid crystal substrates are caused to incline by a pretilt angle smaller than 90° so as to be inverted. The first orientation film 18 and the second orientation film 23 vertically orient the liquid crystal substrates 50a by causing them to incline by the pretilt angle. The direction of the inclination corresponding to the pretilt angle extends along a direction that intersects with the X direction and the Y direction. When a predetermined voltage is applied to the liquid crystal layer 50, the orientation state of the liquid crystal substances 50a changes.

The first orientation film 18 and the second orientation film 23 shown in FIG. 2 are each configured with two layers, but not necessarily. The first orientation film 18 and the second orientation film 23 may each be configured with three or more layers.

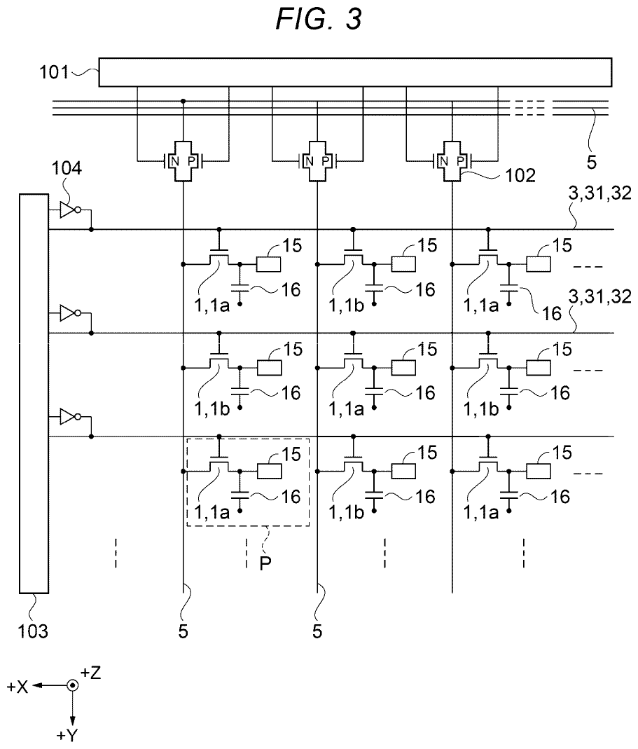

FIG. 3 shows an electrical configuration of the element substrate 10. FIG. 3 is an equivalent circuit diagram showing the electrical configuration of the element substrate 10. Multiple transistors 1, multiple scan lines 3, multiple data lines 5, and multiple pixel electrodes 15 are provided in the display region A1 of the element substrate 10. The multiple scan lines 3 are electrically coupled to the scan line driving circuits 103. The multiple data lines 5 are electrically coupled to the data line driving circuit 101. The multiple scan lines 3 and the multiple data lines 5 are insulated from each other. The transistors 1, the pixel electrodes 15, and capacitance elements 16 are each provided in a region of each of the pixels P segmented by the scan line 3 and the data line 5. The transistor 1, the pixel electrode 15, and the capacitance element 16 constitute a pixel circuit of the pixel P.

The transistors 1 are each a switching element provided in correspondence with the pixel electrode 15. The transistors 1 are each, for example, a thin film transistor (TFT). The transistors 1 are provided in correspondence with the intersections of the multiple scan lines 3 and the multiple data lines 5. The multiple transistors 1 include N-channel transistors 1a and P-channel transistors 1b. The N-channel transistors 1a each correspond to an example of a first transistor of a first electrical conductivity type. The P-channel transistors 1b each correspond to an example of a second transistor of a second electrical conductivity type.

In the element substrate 10 shown in FIG. 3, the N-channel transistors 1a and the P-channel transistors 1b are alternately arranged along the X direction and the Y direction, but not necessarily. The N-channel transistors 1a and the P-channel transistors 1b may be alternately arranged on a row or column basis, or may be alternately arranged on a predetermined number basis. The N-channel transistors 1a and the P-channel transistors 1b are preferably alternately arranged along the X direction and the Y direction.

The scan lines 3 are each electrically coupled to a gate electrode 73 of the corresponding transistor 1. The scan lines 3 shown in FIG. 3 extend along the X direction. The scan lines 3 include N-channel scan lines 31 provided in correspondence with the N-channel transistors 1a and P-channel scan lines 32 provided in correspondence with the P-channel transistors 1b. The N-channel scan lines 31 correspond to an example of a first scan line. The P-channel scan lines 32 correspond to an example of a second scan line. The arrangement of the N-channel scan lines 31 and the P-channel scan lines 32 will be described later. The N-channel scan lines 31 each simultaneously control on and off of the N-channel transistors 1a provided in the same row. The P-channel scan lines 32 each simultaneously control on and off of the P-channel transistors 1b provided in the same row. The N-channel scan lines 31 and the P-channel scan lines 32 are electrically coupled to the scan line driving circuits 103. The scan lines 3 supply scan signals supplied from the scan line driving circuits 103 to the pixels P. The scan signals are supplied to the scan lines 3 at predetermined timings.

The data lines 5 are each electrically coupled to a first data-line-side source-drain region 71d of the corresponding N-channel transistor 1a or a second data-line-side source-drain region 72d of the corresponding P-channel transistor 1b. The first data-line-side source-drain region 71d and the second data-line-side source-drain region 72d will be described later. The data lines 5 shown in FIG. 3 extend along the Y direction. The data lines 5 are electrically coupled to the data line driving circuit 101. The data lines 5 supply image signals supplied from the data line driving circuit 101 to the pixels P.

The pixel electrodes 15 are each electrically coupled to a first pixel-electrode-side source-drain region 71p of the corresponding N-channel transistor 1a or a second pixel-electrode-side source-drain region 72p of the corresponding P-channel transistor 1b. The first pixel-electrode-side source-drain region 71p and the second pixel-electrode-side source-drain region 72p will be described later. When any of the transistors 1 is turned on for a fixed period by the input of the scan signal, the image signal is applied to the pixel electrode 15 at a predetermined timing. The image signal is written to the liquid crystal layer 50 at a predetermined level via the pixel electrode 15. The image signal is held for the fixed period between the pixel electrode 15 and the common electrode 22, which sandwich the liquid crystal layer 50. The orientation state of the liquid crystal substances 50a is changed by the potential applied in accordance with the image signal.

The capacitance elements 16 each have two electrodes. One electrode of the capacitance element 16 is electrically coupled to a capacitance line 7, which will be described later. The other electrode of the capacitance element 16 is electrically coupled to the pixel electrode 15. The capacitance element 16 prevents leakage of the image signal held by the pixel electrode 15.

Multiple transmission gates 102 are provided between the data line driving circuit 101 and the data lines 5. The multiple transmission gates 102 are provided in correspondence with the data lines 5. The transmission gates 102 are each configured with a complementary transistor by way of example. The transmission gates 102 each function as a switch. The transmission gates 102 are each configured with a CMOS (complementary metal-oxide-semiconductor) device by way of example. Providing the transmission gates 102 reduces potential fluctuation caused by parasitic capacitance produced in the data lines 5. The transmission gates 102 correspond to an example of a complementary sampling transistor.

The liquid crystal device 100 preferably includes the transmission gates 102 electrically coupled to the data lines 5.

Providing the transmission gates 102 reduces the potential fluctuation caused by the parasitic capacitance produced in the data lines 5.

Inverter circuits 104 are provided between the scan line driving circuits 103 and the scan lines 3. The inverter circuits 104 invert gate signals. As an example, the inverter circuits 104 invert a gate signal generated for a pixel P where an N-channel transistor 1a is provided to a gate signal for a pixel P where a P-channel transistor 1b is provided.

### First Embodiment

In a first embodiment, the configuration of a first element substrate 10a is shown. The first element substrate 10a is an example of the element substrate 10. In the first element substrate 10a, pixel relay electrodes 81 and data line relay electrodes 82 are disposed between the N-channel scan lines 31 and the P-channel scan lines 32.

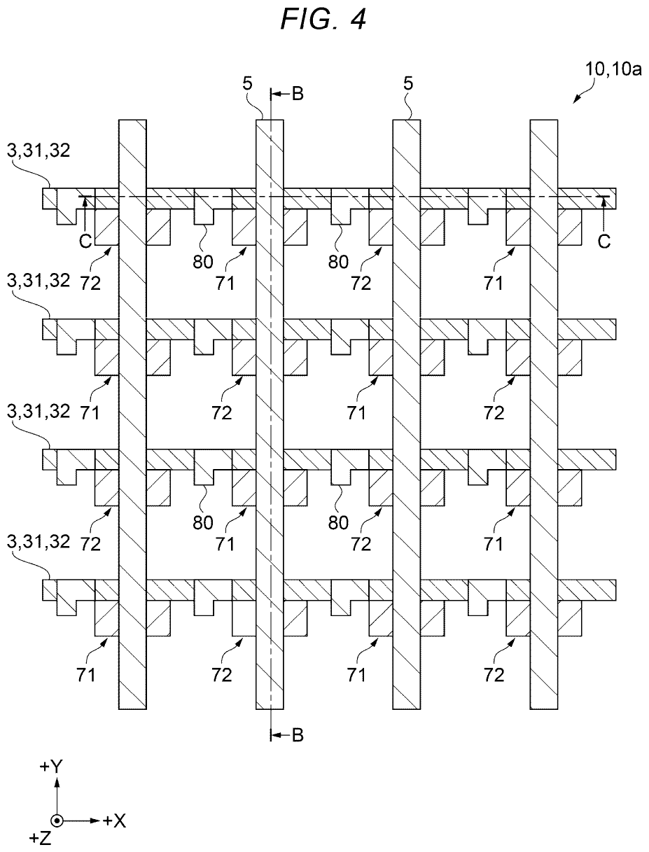

FIG. 4 shows a schematic configuration of the first element substrate 10a. FIG. 4 shows a portion of the first element substrate 10a in the display region A1 in the plan view viewed in the +Z direction. FIG. 4 shows the scan lines 3, the data lines 5, and relay electrodes 80. First semiconductor layers 71 and second semiconductor layers 72 are disposed at positions shifted from the data lines 5 in the −Z direction. FIG. 4 shows a line B-B and a line C-C. The line B-B and the line C-C are imaginary lines.

The relay electrodes 80 are electrically coupled to the pixel relay electrodes 81 and the pixel electrodes 15. The drain potential is applied to the relay electrodes 80. The relay electrodes 80 are formed in the same layer as the multiple data lines 5.

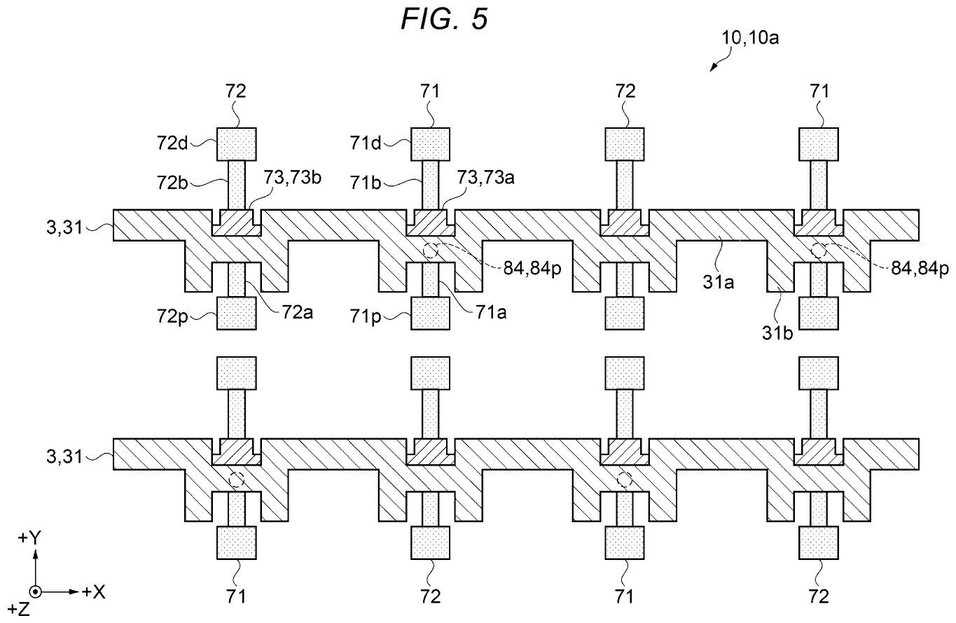

FIG. 5 shows another schematic configuration of the first element substrate 10a. FIG. 5 shows a portion of the first element substrate 10a in the display region A1 in the plan view viewed from a position shifted from the N-channel scan lines 31 in the +Z direction. FIG. 5 shows the multiple first semiconductor layers 71, the multiple second semiconductor layers 72, the multiple gate electrodes 73, the multiple N-channel scan lines 31, and multiple first gate coupling contact holes 84.

The first semiconductor layers 71 each include the N-channel transistor 1a. The N-channel transistor 1a has a lightly doped drain (LDD) structure. The first semiconductor layers 71 each include the first pixel-electrode-side source-drain region 71p, a first pixel-electrode-side LDD region 71a, a first channel region 71c, a first data-line-side LDD region 71b, and the first data-line-side source-drain region 71d. The first semiconductor layers 71 are made, for example, of polysilicon. The region excluding the first channel region 71c is doped with a predetermined impurity that improves electrical conductivity.

The first pixel-electrode-side source-drain region 71p and the first data-line-side source-drain region 71d are made, for example, of an N-type silicon semiconductor. The first channel region 71c is made of a P-type silicon semiconductor. The first pixel-electrode-side source-drain region 71p and the first data-line-side source-drain region 71d correspond to an example of a first source-drain region.

The first pixel-electrode-side LDD region 71a is disposed between the first pixel-electrode-side source-drain region 71p and the first channel region 71c. The impurity concentration in the first pixel-electrode-side LDD region 71a is lower than the impurity concentration in the first pixel-electrode-side source-drain region 71p and the impurity concentration in the first data-line-side source-drain region 71d. The first pixel-electrode-side LDD region 71a corresponds to an example of an LDD region.

The first data-line-side LDD region 71b is disposed between the first data-line-side source-drain region 71d and the first channel region 71c. The impurity concentration in the first data-line-side LDD region 71b is lower than the impurity concentration in the first pixel-electrode-side source-drain region 71p and the impurity concentration in the first data-line-side source-drain region 71d. The first data-line-side LDD region 71b corresponds to an example of the LDD region.

The second semiconductor layers 72 each include the P-channel transistor 1b. The P-channel transistor 1b has the lightly doped drain (LDD) structure. The second semiconductor layers 72 each include the second pixel-electrode-side source-drain region 72p, a second pixel-electrode-side LDD region 72a, a second channel region 72c, a second data-line-side LDD region 72b, and the second data-line-side source-drain region 72d. The second semiconductor layers 72 are made, for example, of polysilicon. The region excluding the second channel region 72c is doped with a predetermined impurity that improves electrical conductivity.

The second pixel-electrode-side source-drain region 72p and the second data-line-side source-drain region 72d are made, for example, of a P-type silicon semiconductor. The second channel region 72c is made of an N-type silicon semiconductor. The second pixel-electrode-side source-drain region 72p and the second data-line-side source-drain region 72d correspond to an example of a second source-drain region.

The second pixel-electrode-side LDD region 72a is disposed between the second pixel-electrode-side source-drain region 72p and the second channel region 72c. The impurity concentration in the second pixel-electrode-side LDD region 72a is lower than the impurity concentration in the second pixel-electrode-side source-drain region 72p and the impurity concentration in the second data-line-side source-drain region 72d. The second pixel-electrode-side LDD region 72a corresponds to an example of the LDD region.

The second data-line-side LDD region 72b is disposed between the second data-line-side source-drain region 72d and the second channel region 72c. The impurity concentration in the second data-line-side LDD region 72b is lower than the impurity concentration in the second pixel-electrode-side source-drain region 72p and the impurity concentration in the second data-line-side source-drain region 72d. The second data-line-side LDD region 72b corresponds to an example of the LDD region.

The multiple gate electrodes 73 include first gate electrodes 73a and second gate electrodes 73b. The first gate electrodes 73a are each disposed on the first semiconductor layer 71 via a gate insulating layer 99. The first gate electrodes 73a correspond to an example of a first gate electrode. The first gate electrodes 73a are each disposed at a position where the first gate electrode 73a overlaps with the first channel region 71c in the plan view viewed in the +Z direction. The second gate electrodes 73b are each disposed on the second semiconductor layer 72 via the gate insulating layer 99. The second gate electrodes 73b correspond to an example of a second gate electrode. The second gate electrodes 73b are each disposed at a position where the second gate electrode 73b overlaps with the second channel region 72c in the plan view viewed in the +Z direction.

The gate electrodes 73 are formed, for example, by doping polysilicon with a predetermined impurity that improves electrical conductivity. The gate electrodes 73 may be made of an electrically conductive material such as a metal, a metal silicide, or a metal compound.

The N-channel scan lines 31 are disposed at positions where the first semiconductor layers 71 and the second semiconductor layers 72 intersect with each other. The N-channel scan lines 31 are disposed at positions shifted in the +Z direction from the first semiconductor layers 71 and the second semiconductor layers 72. The N-channel scan lines 31 are made of a light blocking, electrically conductive material. The term “light blocking” indicates blocking part of visible light, and the transmittance for visible light is preferably lower than 50%. Examples of the electrically conductive material include metal such as tungsten, titanium, chromium, iron, and aluminum, metal nitride, and metal silicide. The N-channel scan lines 31 each include a body 31a and protrusions 31b.

The body 31a extends in the +X direction and is coupled to the protrusions 31b. The +X direction corresponds to an example of a first direction. The protrusions 31b are coupled to the body 31a and extend in the −Y direction. The −Y direction corresponds to an example of a second direction. The protrusions 31b are disposed along the first semiconductor layers 71 or the second semiconductor layers 72. The protrusions 31b disposed along the first semiconductor layers 71 extend along the first pixel-electrode-side LDD regions 71a and the first channel regions 71c. The protrusions 31b disposed along the second semiconductor layers 72 extend along the second pixel-electrode-side LDD regions 72a and the second channel regions 72c. Providing the protrusions 31b improves the light blocking performance.

The first gate coupling contact holes 84 electrically couple the first gate electrodes 73a and the N-channel scan lines 31 to each other. The first gate coupling contact holes 84 each include a first contact plug 84p. The first contact plug 84p is made, for example, of tungsten.

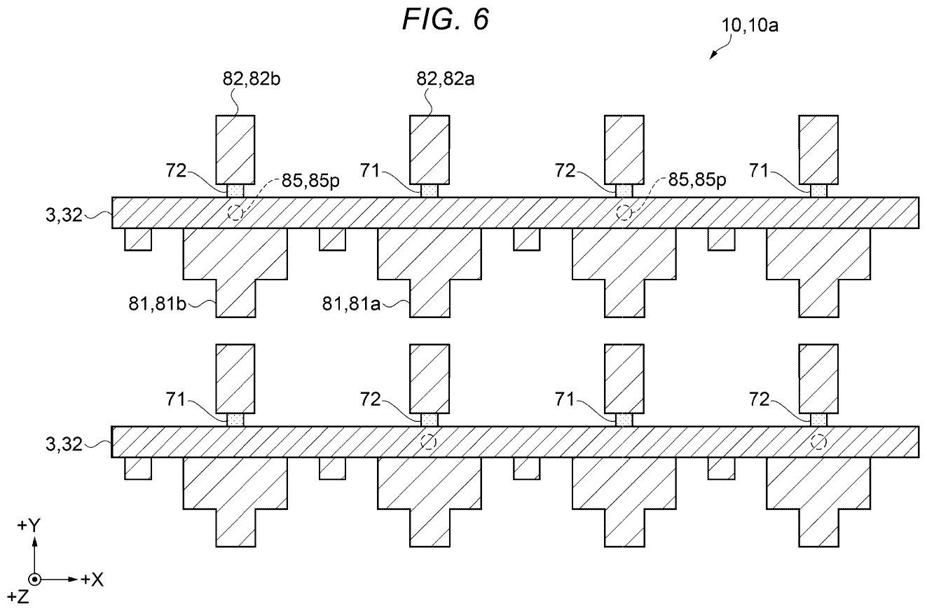

FIG. 6 shows another schematic configuration of the first element substrate 10a. FIG. 6 shows a portion of the first element substrate 10a in the display region A1 in the plan view viewed from a position shifted from the P-channel scan lines 32 in the +Z direction. FIG. 6 shows the multiple P-channel scan lines 32, the multiple first semiconductor layers 71, the multiple second semiconductor layers 72, multiple second gate coupling contact holes 85, the multiple pixel relay electrodes 81, and the multiple data line relay electrodes 82.

The P-channel scan lines 32 are disposed at positions where the first semiconductor layers 71 and the second semiconductors layer 72 intersect with each other. The P-channel scan lines 32 are disposed at positions shifted from the N-channel scan lines 31 in the +Z direction. The P-channel scan lines 32 are made of a light blocking, electrically conductive material. Examples of the electrically conductive material include metal such as tungsten, titanium, chromium, iron, and aluminum, metal nitride, and metal silicide.

The second gate coupling contact holes 85 electrically couple the second gate electrodes 73b and the P-channel scan lines 32 to each other. The second gate coupling contact holes 85 each include a second contact plug 85p. The second contact plug 85p is made, for example, of tungsten.

The multiple pixel relay electrodes 81 include first pixel relay electrodes 81a and second pixel relay electrodes 81b. The first pixel relay electrodes 81a are electrically coupled to the first pixel-electrode-side source-drain regions 71p of the first semiconductor layers 71. The first pixel relay electrodes 81a are disposed at positions shifted in the +Z direction from the first pixel-electrode-side source-drain regions 71p. The first pixel relay electrodes 81a correspond to an example of a first source-drain electrode. The second pixel relay electrodes 81b are electrically coupled to the second pixel-electrode-side source-drain regions 72p of the second semiconductor layers 72. The second pixel relay electrodes 81b are disposed at positions shifted in the +Z direction from the second pixel-electrode-side source-drain regions 72p. The second pixel relay electrodes 81b correspond to an example of a second source-drain electrode. The pixel relay electrodes 81 block light toward the first semiconductor layers 71 and the second semiconductor layers 72.

The multiple data line relay electrodes 82 include first data line relay electrodes 82a and second data line relay electrodes 82b. The first data line relay electrodes 82a are electrically coupled to the first data-line-side source-drain regions 71d of the first semiconductor layers 71. The first data line relay electrodes 82a are disposed at positions shifted in the +Z direction from the first data-line-side source-drain regions 71d. The first data line relay electrodes 82a correspond to an example of the first source-drain electrode. The second data line relay electrodes 82b are electrically coupled to the second data-line-side source-drain regions 72d of the second semiconductor layers 72. The second data line relay electrodes 82b are disposed at positions shifted in the +Z direction from the second data-line-side source-drain regions 72d. The second data line relay electrodes 82b correspond to an example of the second source-drain electrode. The data line relay electrodes 82 block light toward the first semiconductor layers 71 and the second semiconductor layers 72.

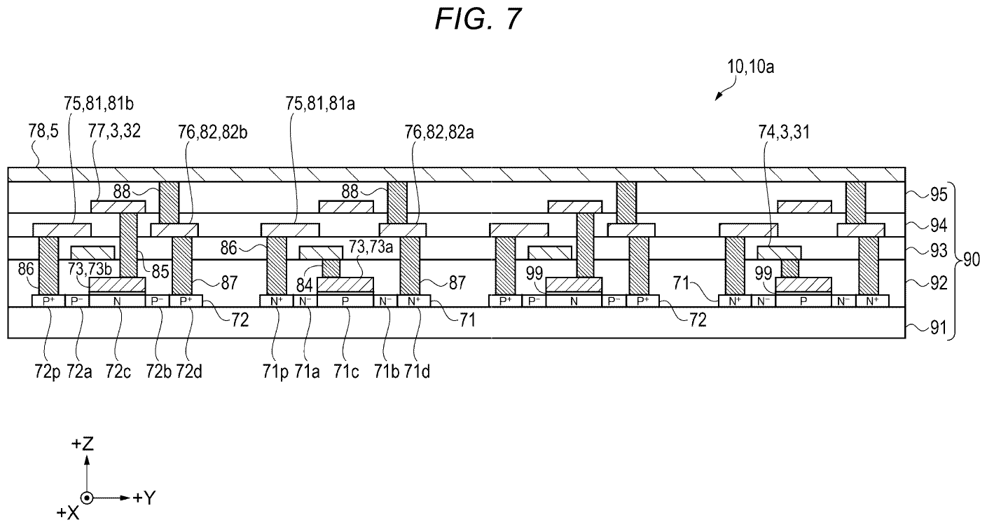

FIG. 7 shows another schematic configuration of the first element substrate 10a. FIG. 7 shows a YZ cross section containing the line B-B shown in FIG. 4. FIG. 7 shows a portion of the first element substrate 10a in the display region A1 in a cross-sectional view viewed in the +X direction. FIG. 7 shows the first semiconductor layers 71, the second semiconductor layers 72, the first gate electrodes 73a, the second gate electrodes 73b, first light blocking layers 74, first relay layers 75, second relay layers 76, second light blocking layers 77, electrically conductive layers 78, the first gate coupling contact holes 84, the second gate coupling contact holes 85, first contact holes 86, second contact holes 87, data line coupling contact holes 88, and an insulating layer group 90. The insulating layer group 90 includes a first interlayer insulating layer 91, a second interlayer insulating layer 92, a third interlayer insulating layer 93, a fourth interlayer insulating layer 94, a fifth interlayer insulating layer 95, and the gate insulating layers 99.

The first interlayer insulating layer 91 is a light transmissive, insulating layer. The first interlayer insulating layer 91 is made, for example, of an inorganic material such as silicon oxide. The first interlayer insulating layer 91 is formed on the element substrate base 11.

The first semiconductor layers 71 and the second semiconductor layers 72 are provided on the first interlayer insulating layer 91. In the first element substrate 10a shown in FIG. 7, the second semiconductor layers 72 and the first semiconductor layers 71 are alternately arranged in this order from the side facing the negative end in the Y direction. The first semiconductor layers 71 and the second semiconductor layers 72 are disposed at positions adjacent to each other.

The second interlayer insulating layer 92 is provided on the first semiconductor layers 71 and the second semiconductor layers 72. The second interlayer insulating layer 92 is a light transmissive, insulating layer. The second interlayer insulating layer 92 is made, for example, of an inorganic material such as silicon oxide.

The first gate electrodes 73a are provided above the first channel regions 71c in the first semiconductor layers 71. The first gate electrodes 73a are provided above the first semiconductor layer 71 via the gate insulating layers 99.

The second gate electrodes 73b are provided above the second channel regions 72c in the second semiconductor layers 72. The second gate electrodes 73b are provided above the second semiconductor layers 72 via the gate insulating layers 99.

The gate insulating layers 99 are each an insulating layer. The gate insulating layers 99 are made, for example, of silicon oxide deposited by thermal oxidation, chemical vapor deposition (CVD), or the like.

The first light blocking layers 74 are disposed on the second interlayer insulating layer 92. The first light blocking layers 74 are disposed between the first semiconductor layers 71 and a group of the first pixel relay electrodes 81a and the first data line relay electrodes 82a along the Z direction. The first light blocking layers 74 disposed between the second semiconductor layers 72 and a group of the second pixel relay electrodes 81b and the second data line relay electrodes 82b along the Z direction. The first light blocking layers 74 are each a thin film extending along the X direction. The first light blocking layers 74 correspond to an example of a first layer. The first light blocking layers 74 include the N-channel scan lines 31. The N-channel scan lines 31 are disposed in the first light blocking layers 74 and electrically coupled to the first gate electrodes 73a.

The first gate coupling contact holes 84 pass through the second interlayer insulating layer 92. The first gate coupling contact holes 84 electrically couple the first gate electrodes 73a and the N-channel scan lines 31 to each other to cause them to be electrically conductive to each other.

The third interlayer insulating layer 93 is provided on the first light blocking layers 74. The third interlayer insulating layer 93 is provided between a group of the pixel relay electrodes 81 and the data line relay electrodes 82, and the N-channel scan lines 31. The third interlayer insulating layer 93 corresponds to an example of a second insulating layer. The third interlayer insulating layer 93 is a light transmissive, insulating layer. The third interlayer insulating layer 93 is made, for example, of an inorganic material such as silicon oxide.

The multiple first relay layers 75 are disposed on the third interlayer insulating layer 93. The first relay layers 75 are made of a light blocking, electrically conductive material. The multiple first relay layers 75 each include one of the first pixel relay electrode 81a and the second pixel relay electrode 81b. The first pixel relay electrodes 81a are electrically coupled to the first pixel-electrode-side source-drain regions 71p of the first semiconductor layers 71. The second pixel relay electrodes 81b are electrically coupled to the second pixel-electrode-side source-drain regions 72p of the second semiconductor layers 72.

The first contact holes 86 pass through the second interlayer insulating layer 92 and the third interlayer insulating layer 93. The first contact holes 86 are each electrically coupled to one of the first pixel-electrode-side source-drain region 71p of the corresponding first semiconductor layer r 71 and the second pixel-electrode-side source-drain region 72p of the corresponding second semiconductor layer 72 to each other to cause them to be electrically conductive to each other.

The multiple second relay layers 76 are disposed on the third interlayer insulating layer 93. The second relay layers 76 are made of a light blocking, electrically conductive material. The multiple second relay layers 76 each include one of the first data line relay electrode 82a and the second data line relay electrode 82b. The first data line relay electrodes 82a are electrically coupled to the first data-line-side source-drain regions 71d of the first semiconductor layers 71. The second data line relay electrodes 82b are electrically coupled to the second data-line-side source-drain regions 72d of the second semiconductor layers 72.

The second contact holes 87 pass through the second interlayer insulating layer 92 and the third interlayer insulating layer 93. The multiple second contact holes 87 are each electrically coupled to one of the first data line-side source-drain region 71d of the corresponding first semiconductor layer 71 and the second data-line-side source-drain region 72d of the corresponding second semiconductor layer 72 to each other to cause them to be electrically conductive to each other.

The fourth interlayer insulating layer 94 is provided on the first relay layers 75 including the pixel relay electrodes 81 and the second relay layers 76 including the data line relay electrodes 82. The fourth interlayer insulating layer 94 is provided between a group of the first pixel relay electrodes 81a and the second pixel relay electrodes 81b, and the P-channel scan lines 32. The fourth interlayer insulating layer 94 is provided between a group of the first data line relay electrodes 82a and the second data line relay electrodes 82b, and the P-channel scan lines 32. The fourth interlayer insulating layer 94 corresponds to an example of a first insulating layer. The fourth interlayer insulating layer 94 is a light transmissive, insulating layer. The fourth interlayer insulating layer 94 is made, for example, of an inorganic material such as silicon oxide. The fourth interlayer insulating layer 94 may be made of the same material as the third interlayer insulating layer 93.

The second light blocking layers 77 are disposed on the fourth interlayer insulating layer 94. The second light blocking layers 77 are disposed between the data lines 5 and a group of the pixel relay electrodes 81 and the data line relay electrodes 82 along the Z direction. The second light blocking layers 77 are disposed on the side opposite the first semiconductor layers 71 with the first pixel relay electrodes 81a and the first data line relay electrodes 82a interposed therebetween. The second light blocking layers 77 are e disposed on the side opposite the second semiconductor layers 72 with the second pixel relay electrodes 81b and the second data line relay electrodes 82b interposed therebetween. The second light blocking layers 77 are each a thin film extending along the X direction. The second light blocking layers 77 correspond to an example of a second layer. The second light blocking layers 77 include the P-channel scan lines 32. The P-channel scan lines 32 are disposed in the second light blocking layers 77 and electrically coupled to the second gate electrodes 73b.

The second gate coupling contact holes 85 pass through the second interlayer insulating layer 92, the third interlayer insulating layer 93, and the fourth interlayer insulating layer 94. The second gate coupling contact holes 85 electrically couple the second gate electrodes 73b and the P-channel scan lines 32 to each other to cause them to be electrically conductive to each other.

The fifth interlayer insulating layer 95 is provided on the fourth interlayer insulating layer 94 and the second light blocking layers 77. The fifth interlayer insulating layer 95 is a light transmissive, insulating layer. The fifth interlayer insulating layer 95 is made, for example, of an inorganic material such as silicon oxide.

The electrically conductive layers 78 are disposed on the fifth interlayer insulating layer 95. The electrically conductive layers 78 shown in FIG. 7 are each a thin film extending along the Y direction. The electrically conductive layers 78 are made of a light blocking, electrically conductive material. Examples of the electrically conductive material that forms the electrically conductive layers 78 include metal such as tungsten, titanium, chromium, iron, and aluminum, metal nitride, and metal silicide. The electrically conductive layers 78 include the data lines 5. The data lines 5 are disposed in the electrically conductive layers 78 and electrically coupled to the first data-line-side source-drain regions 71d and the second data-line-side source-drain regions 72d via the data line relay electrodes 82.

The data line coupling contact holes 88 pass through the fourth interlayer insulating layer 94 and the fifth interlayer insulating layer 95. The data line coupling contact holes 88 electrically couple the data lines 5 and the data line relay electrodes 82 to each other to cause them to be electrically conductive to each other.

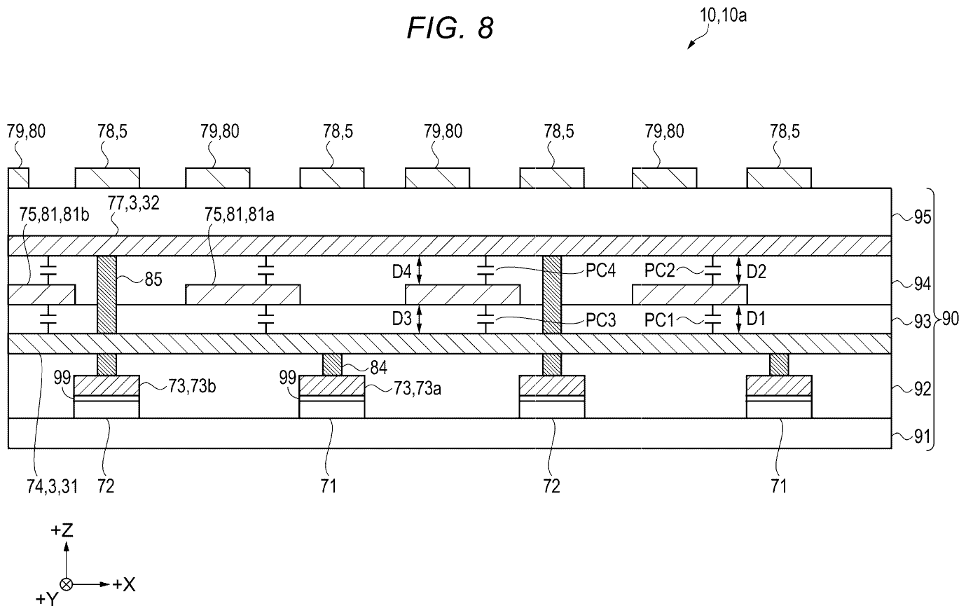

FIG. 8 shows another schematic configuration of the first element substrate 10a. FIG. 8 shows an XZ cross section containing the line C-C shown in FIG. 4. FIG. 8 shows a portion of the first element substrate 10a in the display region A1 in a cross-sectional view viewed in the −Y direction. FIG. 8 shows the first semiconductor layers 71, the second semiconductor layers 72, the gate electrodes 73, the first light blocking layers 74, the first relay layers 75, the second light blocking layers 77, the electrically conductive layers 78, the relay electrodes 80, the pixel relay electrodes 81, the first gate coupling contact holes 84, the second gate coupling contact holes 85, and the insulating layer group 90. The insulating layer group 90 includes the first interlayer insulating layer 91, the second interlayer insulating layer 92, the third interlayer insulating layer 93, the fourth interlayer insulating layer 94, the fifth interlayer insulating layer 95, and the gate insulating layers 99.

FIG. 8 shows the first gate coupling contact holes 84 and the second gate coupling contact holes 85 to clearly show the arrangement thereof, but the first gate coupling contact holes 84 and the second gate coupling contact holes 85 are not disposed in the same cross section.

FIG. 8 diagrammatically shows first parasitic capacitance PC1, second parasitic capacitance PC2, third parasitic capacitance PC3, and fourth parasitic capacitance PC4. The first parasitic capacitance PC1 is produced between the N-channel scan lines 31 and the first pixel relay electrodes 81a. The second parasitic capacitance PC2 is produced between the P-channel scan lines 32 and the first pixel relay electrodes 81a. The third parasitic capacitance PC3 is produced between the N-channel scan lines 31 and the second pixel relay electrodes 81b. The fourth parasitic capacitance PC4 is produced between the P-channel scan lines 32 and the second pixel relay electrodes 81b.

The first pixel relay electrodes 81a and the second pixel relay electrodes 81b are disposed between the N-channel scan lines 31 and the P-channel scan lines 32 along the Z direction. First gate potential is applied to the N-channel scan lines 31. Second gate potential having a phase opposite the phase of the first gate potential is applied to the P-channel scan lines 32. The potential applied to the pixel electrodes 15 is supplied to the first pixel relay electrodes 81a and the second pixel relay electrodes 81b. The first gate potential and the second gate potential cancel the influence of the first parasitic capacitance PC1 and the second parasitic capacitance PC2 on the potential applied to the first pixel relay electrodes 81a. Similarly, the first gate potential and the second gate potential cancel the influence of the third parasitic capacitance PC3 and the fourth parasitic capacitance PC4 on the potential applied to the second pixel relay electrodes 81b. Fluctuation of the potential applied to the pixel electrodes 15 due to the parasitic capacitance is reduced. Failure in display operation of the liquid crystal device 100 due to the potential fluctuation can be suppressed.

FIG. 8 shows a first distance D1, a second distance D2, a third distance D3, and a fourth distance D4. The first distance D1 is a distance between the N-channel scan lines 31 and the first pixel relay electrodes 81a along the Z direction. The second distance D2 is a distance between the P-channel scan lines 32 and the first pixel relay electrodes 81a along the Z direction. The third distance D3 is a distance between the N-channel scan lines 31 and the second pixel relay electrodes 81b along the Z direction. The fourth distance D4 is a distance between the P-channel scan lines 32 and the second pixel relay electrodes 81b along the Z direction. The first distance D1 and the third distance D3 are equal to each other. The second distance D2 and the fourth distance D4 are equal to each other. The first distance D1, the second distance D2, the third distance D3, and the fourth distance D4 are set as appropriate.

The liquid crystal device 100 includes the N-channel transistors 1a, the P-channel transistors 1b, the first pixel relay electrodes 81a electrically coupled to the first pixel-electrode-side source-drain regions 71p of the N-channel transistors 1a, the second pixel relay electrodes 81b electrically coupled to the second pixel-electrode-side source-drain regions 72p of the P-channel transistor 1b, the N-channel scan lines 31 disposed in the first light blocking layers 74 between the N-channel transistors 1a and the first pixel relay electrodes 81a and electrically coupled to the first gate electrodes 73a of the N-channel transistors 1a, and the P-channel scan lines 32 disposed in the second light blocking layers 77 on the side opposite the P-channel transistors 1b with the second pixel relay electrodes 81b interposed therebetween and electrically coupled to the second gate electrodes 73b of the P-channel transistors 1b.

Disposing the pixel relay electrodes 81 between the N-channel scan lines 31 and the P-channel scan lines 32 reduces the fluctuation of the potential applied to the pixel electrodes 15 due to the parasitic capacitance. Failure in display operation of the liquid crystal device 100 due to the potential fluctuation can be suppressed.

In the plan view viewed in the +Z direction, the N-channel transistors 1a and the P-channel transistors 1b are preferably disposed adjacent to each other.

The influence of the parasitic capacitance produced in the element substrate 10 is further suppressed.

The liquid crystal device 100 preferably includes the fourth interlayer insulating layer 94 disposed in a layer between the group of the first pixel relay electrodes 81a and the second pixel relay electrodes 81b, and the P-channel scan lines 32, and the third interlayer insulating layer 93 disposed in a layer between the group of the first pixel relay electrodes 81a and the second pixel relay electrodes 81b, and the N-channel scan lines 31, the third interlayer insulating layer 93 being made of the same material as the fourth interlayer insulating layer 94.

The influence of the parasitic capacitance produced in the element substrate 10 is further suppressed.

It is preferable that the first pixel-electrode-side LDD region 71a is provided between the first pixel-electrode-side source-drain region 71p and the first channel region 71c of each of the N-channel transistors 1a, and the N-channel scan lines 31 each include the body 31a extending in the +X direction and the protrusions 31b extending from the body 31a along the first pixel-electrode-side LDD regions 71a in the −Y direction, which intersects with the +X direction.

Providing the protrusions 31b improves the performance of the blockage of light toward the N-channel transistors 1a.

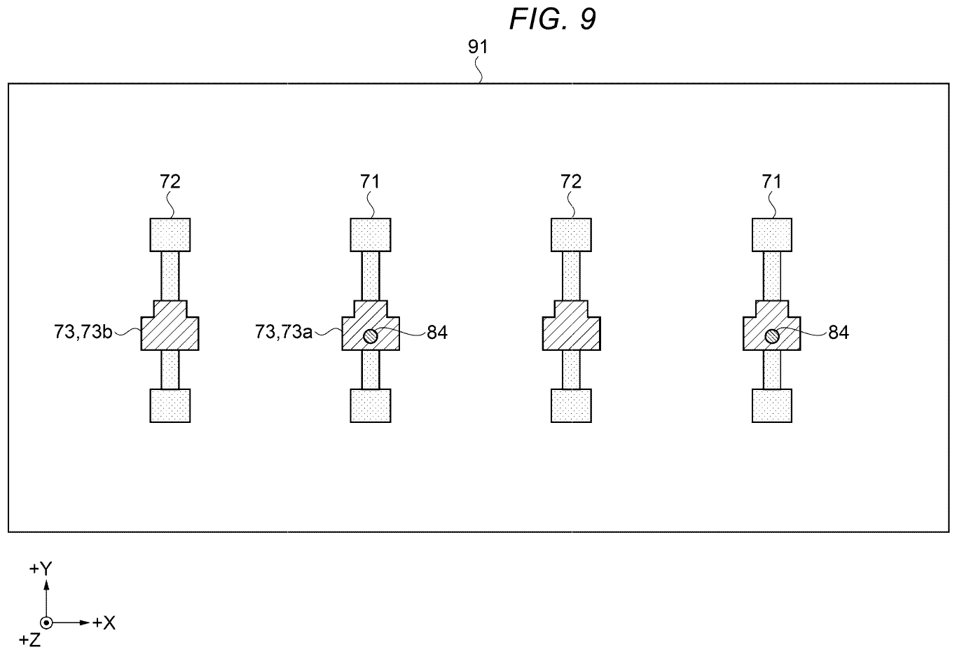

FIGS. 9 to 16 show the process of creating the first element substrate 10a. FIGS. 9 to 16 show a creation process from the formation of the transistors 1 to the formation of the data lines 5. FIGS. 9 to 16 show a portion of the first element substrate 10a in the display region A1 in the plan view viewed in the +Z direction.

FIG. 9 shows a state in which the first semiconductor layers 71, the second semiconductor layers 72, the gate electrodes 73, and the first gate coupling contact holes 84 are formed. The first semiconductor layers 71 correspond to the N-channel transistors 1a. The second semiconductor layers 72 correspond to the P-channel transistors 1b.

The first semiconductor layers 71 and the second semiconductor layers 72 are formed on the first interlayer insulating layer 91. The first semiconductor layers 71 and the second semiconductor layers 72 shown in FIG. 9 extend along the Y direction. The first semiconductor layers 71 and the second semiconductor layers 72 shown in FIG. 9 are alternately disposed along the X direction.

The first gate electrodes 73a are formed on the first semiconductor layers 71 via the gate insulating layers 99. The second gate electrodes 73b are formed on the second semiconductor layers 72 via the gate insulating layers 99. After the first gate electrodes 73a are formed, the second interlayer insulating layer 92 is formed on the first semiconductor layers 71 and the second semiconductor layers 72.

The first gate coupling contact holes 84 are formed on the first gate electrodes 73a. The first gate coupling contact holes 84 are formed in the second interlayer insulating layer 92. The first gate coupling contact holes 84 are formed so as to be electrically couplable to the N-channel scan lines 31.

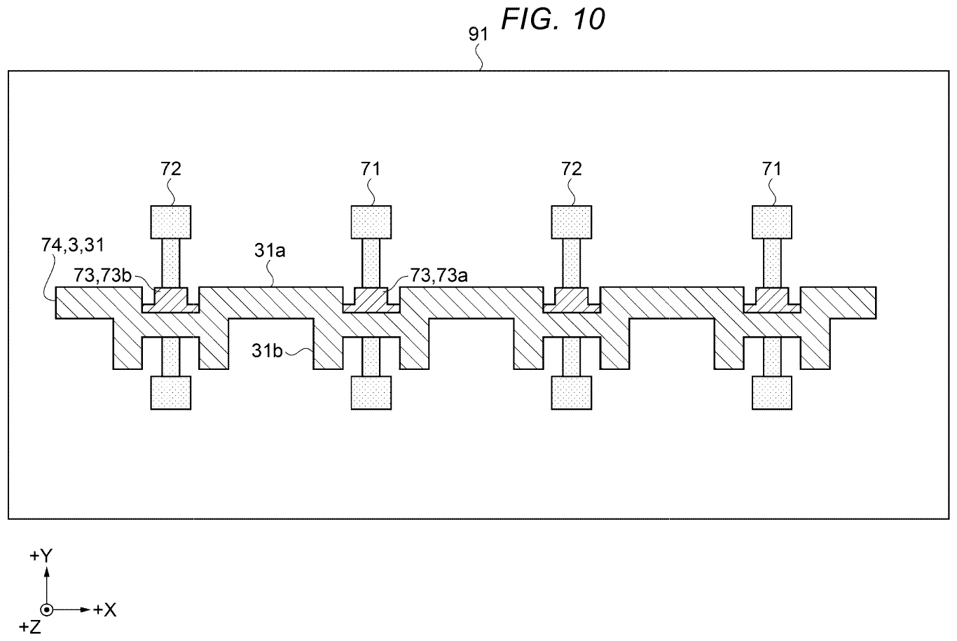

FIG. 10 shows a state in which the first light blocking layers 74 are formed. The first light blocking layers 74 are formed on the second interlayer insulating layer 92. The first light blocking layers 74 extend along the X direction. The first light blocking layers 74 include the N-channel scan lines 31. The N-channel scan lines 31 each include the body 31a and the protrusions 31b.

The N-channel scan lines 31 are formed at positions where the N-channel scan lines 31 overlap with the first gate electrodes 73a and the second gate electrodes 73b. The N-channel scan lines 31 are formed at positions where portions of the first gate electrodes 73a and portions of the second gate electrodes 73b are exposed in the plan view viewed in the +Z direction. The N-channel scan lines 31 are formed on the first gate coupling contact holes 84. After the N-channel scan lines 31 are formed, the third interlayer insulating layer 93 is formed on the N-channel scan lines 31.

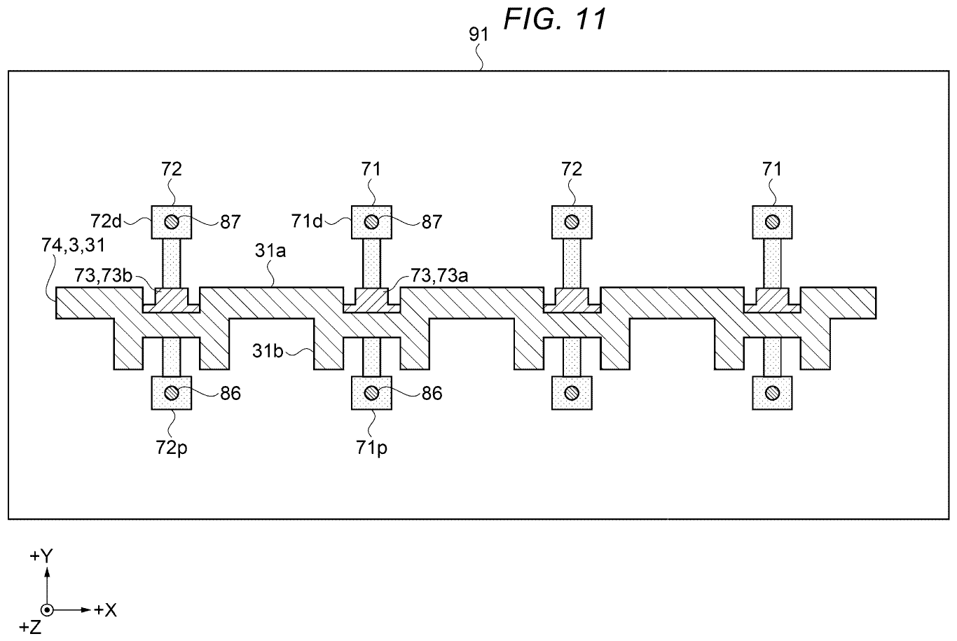

FIG. 11 shows a state in which the first contact holes 86 and the second contact holes 87 are formed. The first contact holes 86 and the second contact holes 87 are formed in the third interlayer insulating layer 93.

The first contact holes 86 are formed on the first pixel-electrode-side source-drain regions 71p of the first semiconductor layers 71 and the second pixel-electrode-side source-drain regions 72p of the second semiconductor layers 72.

The second contact holes 87 are formed on the first data-line-side source-drain regions 71d of the first semiconductor layers 71 and the second data-line-side source-drain regions 72d of the second semiconductor layers 72.

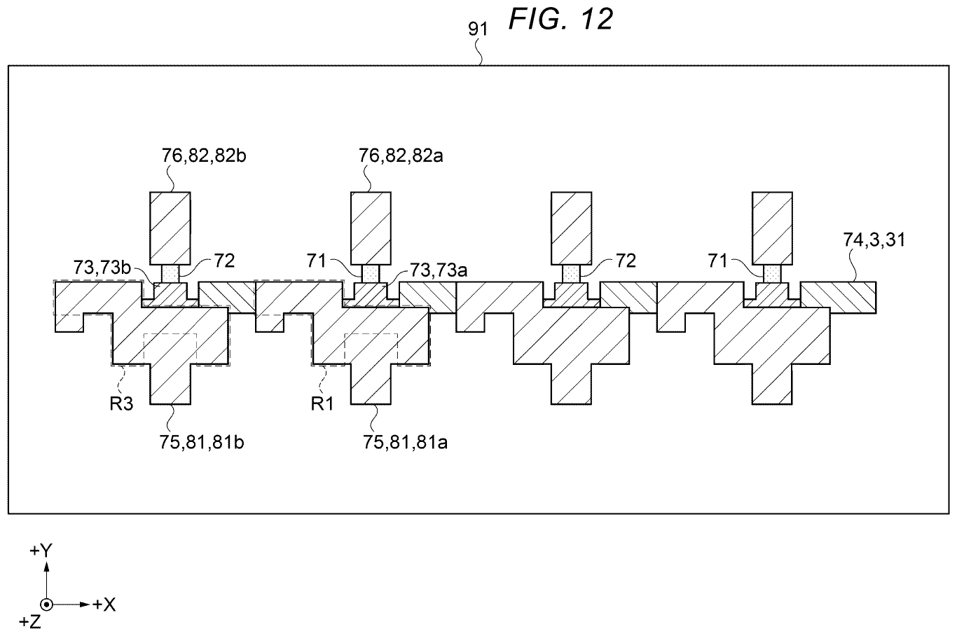

FIG. 12 shows a state in which the first relay layers 75 and the second relay layers 76 are formed. The first relay layers 75 and the second relay layers 76 are formed on the third interlayer insulating layer 93. The first relay layers 75 and the second relay layers 76 are formed with portions of the gate electrodes 73 exposed in the plan view viewed in the +Z direction. The first relay layers 75 include the multiple pixel relay electrodes 81. The second relay layers 76 include the multiple data line relay electrodes 82.

The multiple pixel relay electrodes 81 each include one of the first pixel relay electrode 81a and the second pixel relay electrode 81b. The first pixel relay electrodes 81a are formed on the first pixel-electrode-side source-drain regions 71p of the first semiconductor layers 71 and the N-channel scan lines 31. The first pixel relay electrodes 81a are formed on the protrusions 31b and the bodies 31a of the N-channel scan lines 31. The second pixel relay electrodes 81b are formed on the second pixel-electrode-side source-drain regions 72p of the second semiconductor layers 72 and the N-channel scan lines 31. The second pixel relay electrodes 81b are formed on the protrusions 31b and the bodies 31a of the N-channel scan lines 31.

The multiple data line relay electrodes 82 each include one of the first data line relay electrode 82a and the second data line relay electrode 82b. The first data line relay electrodes 82a are formed on the first data-line-side source-drain 71d of regions the first semiconductor layers 71. The second data line relay electrodes 82b are formed on the second data-line-side source-drain regions 72d of the second semiconductor layers 72.

FIG. 12 shows first overlap regions R1 and third overlap regions R3. The first overlap regions R1 are regions where the N-channel scan lines 31 and the first pixel relay electrodes 81a overlap with each other in the plan view viewed in the +Z direction. The first overlap regions R1 correspond to an example of a first region. The third overlap regions R3 are regions where the N-channel scan lines 31 and the second pixel relay electrodes 81b overlap with each other in the plan view viewed in the +Z direction. The third overlap regions R3 correspond to an example of a third region.

The first overlap regions R1 each include a portion of the body 31a of the N-channel scan line 31 and the protrusions 31b extending along the first semiconductor layers 71. The third overlap regions R3 each include a portion of the body 31a of the N-channel scan line 31 and the protrusions 31b extending along the second semiconductor layers 72.

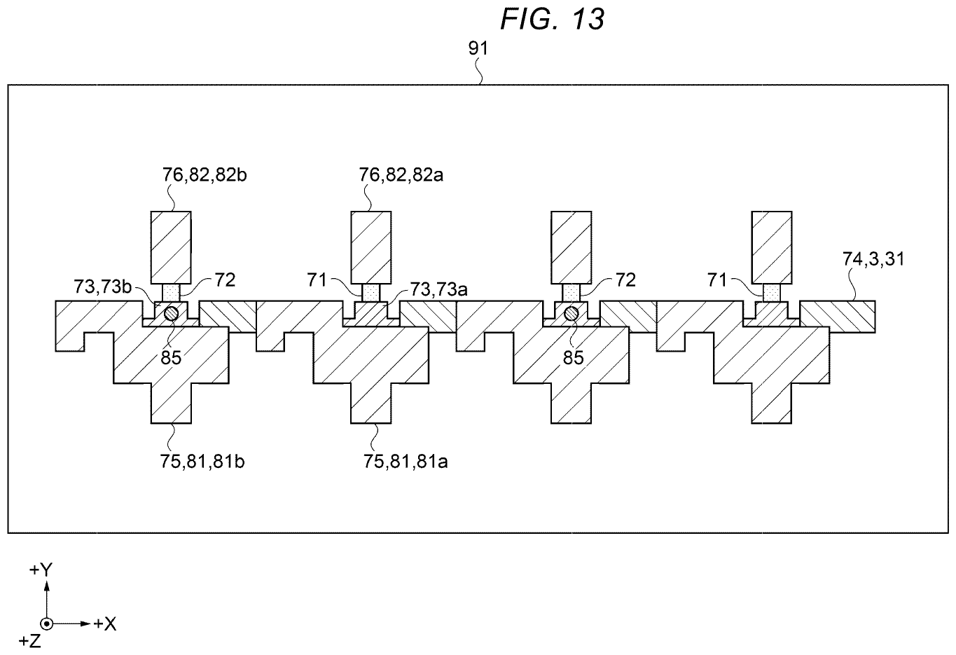

FIG. 13 shows a state in which the second gate coupling contact holes 85 are formed. After the first relay layers 75 and the second relay layers 76 are formed, the fourth interlayer insulating layer 94 is formed on the first relay layers 75 and the second relay layers 76. The second gate coupling contact holes 85 are formed in the second interlayer insulating layer 92, the third interlayer insulating layer 93, and the fourth interlayer insulating layer 94.

The second gate coupling contact holes 85 are formed so as to be electrically couplable to the second gate electrodes 73b on the second semiconductor layers 72. The second gate coupling contact holes 85 are formed at positions shifted in the +Y direction from the first gate coupling contact holes 84.

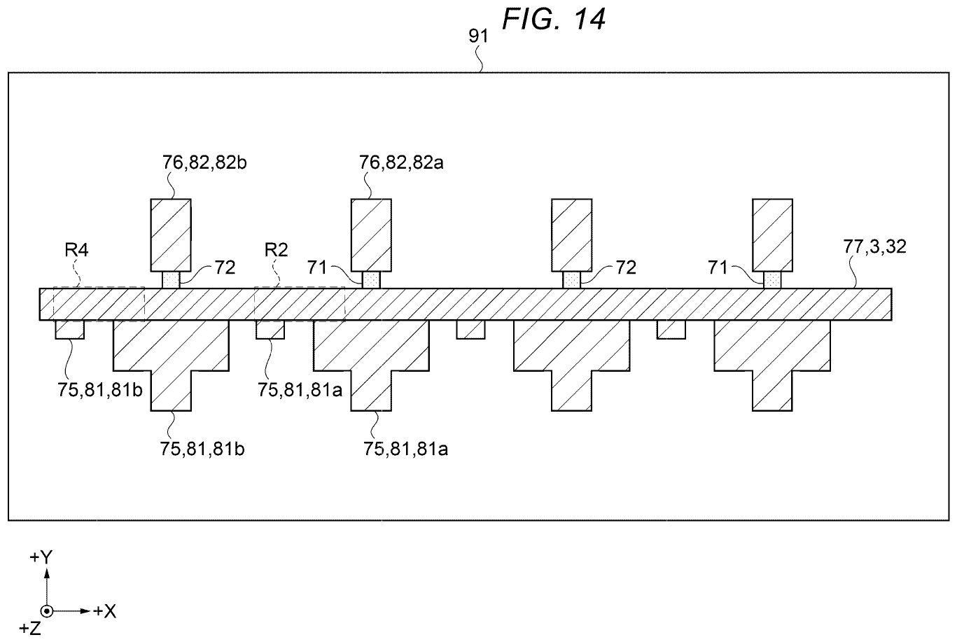

FIG. 14 shows a state in which the second light blocking layers 77 are formed. The second light blocking layers 77 are formed on the fourth interlayer insulating layer 94. The second light blocking layers 77 extend along the X direction. The second light blocking layers 77 include the P-channel scan lines 32.

The P-channel scan lines 32 are formed on the bodies 31a of the N-channel scan lines 31 and the gate electrodes 73. The P-channel scan lines 32 are formed on the second gate coupling contact holes 85. The P-channel scan lines 32 are formed to be electrically couplable to the second gate coupling contact holes 85. The P-channel scan lines 32 are electrically coupled to the second gate electrodes 73b via the second gate coupling contact holes 85.

FIG. 14 shows second overlap regions R2 and fourth overlap regions R4. The second overlap regions R2 are regions where the P-channel scan lines 32 and the first pixel relay electrodes 81a overlap with each other in the plan view viewed in the +Z direction. The second overlap regions R2 correspond to an example of a second region. The fourth overlap regions R4 are regions where the P-channel scan lines 32 and the second pixel relay electrodes 81b overlap with each other in the plan view viewed in the +Z direction. The fourth overlap regions R4 correspond to an example of a fourth region.

The second overlap regions R2 overlap with portions of the first overlap regions R1, where the bodies 31a of the N-channel scan lines 31 overlap with the first pixel relay electrodes 81a. A first area of each of the first overlap regions R1 in the plan view viewed in the +Z direction is greater than a second area of each of the second overlap regions R2 in the plan view viewed in the +Z direction.

The fourth overlap regions R4 overlap with portions of the third overlap regions R3, where the bodies 31a of the N-channel scan lines 31 overlap with the second pixel relay electrodes 81b. A third area of each of the third overlap regions R3 in the plan view viewed in the +Z direction is greater than a fourth area of each of the fourth overlap regions R4 in the plan view viewed in the +Z direction.

When the first area is greater than the second area as shown in FIGS. 12 and 14, the first parasitic capacitance PC1 shown in FIG. 8 is greater than the second parasitic capacitance PC2 shown in FIG. 8. When the first parasitic capacitance PC1 is greater than the second parasitic capacitance PC2, the effect of reducing the potential fluctuation produced in the first pixel relay electrodes 81a decreases. In this case, it is preferable that the first pixel relay electrodes 81a are so formed that the first distance D1 is greater than the second distance D2 in FIG. 8. Forming the first pixel relay electrodes 81a in such a way that the first distance D1 is greater than the second distance D2 allows suppression of the decrease in the effect of reducing the potential fluctuation produced in the first pixel relay electrodes 81a.

When the third area is greater than the fourth area, the third parasitic capacitance PC3 shown in FIG. 8 is greater than the fourth parasitic capacitance PC4 shown in FIG. 8. When the third parasitic capacitance PC3 is greater than the fourth parasitic capacitance PC4, the effect of reducing the potential fluctuation produced in the second pixel relay electrodes 81b decreases. In this case, it is preferable that the second pixel relay electrodes 81b are so formed that the third distance D3 is greater than the fourth distance D4 in FIG. 8. Forming the second pixel relay electrodes 81b in such a way that the third distance D3 is greater than the fourth distance D4 allows suppression of the decrease in the effect of reducing the potential fluctuation produced in the second pixel relay electrodes 81b.

It is preferable that the first area of each of the first overlap regions R1, where the first pixel relay electrodes 81a and the N-channel scan lines 31 overlap with each other in the plan view, is greater than the second area of each of the second overlap regions R2, where the first pixel relay electrodes 81a and the P-channel scan lines 32 overlap with each other, the third area of each of the third overlap regions R3, where the second pixel relay electrodes 81b and the N-channel scan lines 31 overlap with each other in the plan view, is greater than the fourth area of each of the fourth overlap regions R4, where the second pixel relay electrodes 81b and the P-channel scan lines 32 overlap with each other, the first distance D1 between the first pixel relay electrodes 81a and the N-channel scan lines 31 is greater than the second distance D2 between the first pixel relay electrodes 81a and the P-channel scan lines 32, and the third distance D3 between the second pixel relay electrodes 81b and the N-channel scan lines 31 is greater than the fourth distance D4 between the second pixel relay electrodes 81b and the P-channel scan lines 32.

The decrease in the effect of reducing the potential fluctuation produced in the first pixel relay electrodes 81a and the second pixel relay electrodes 81b can be suppressed.

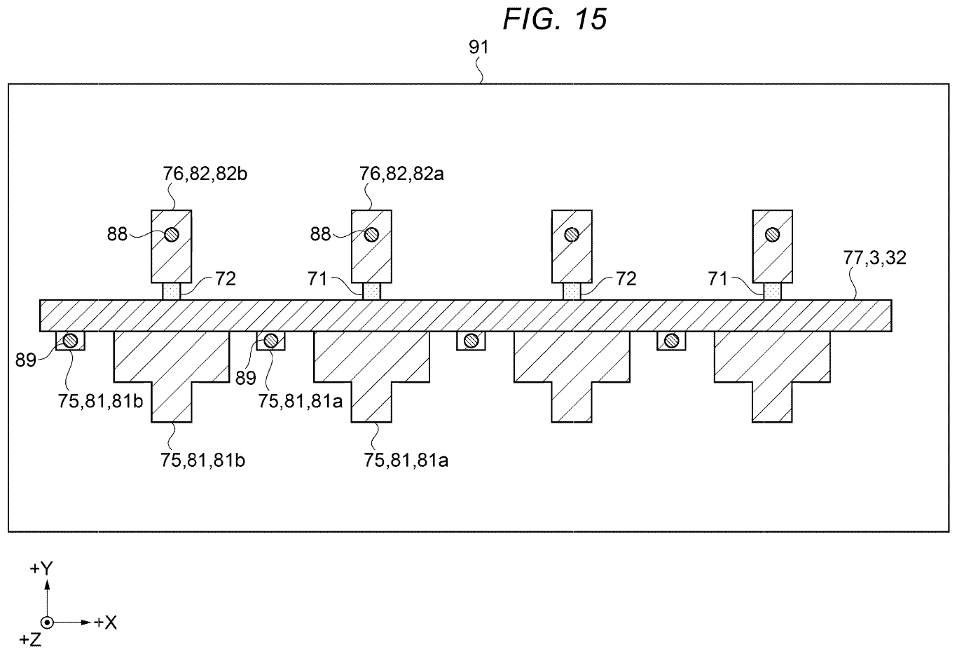

FIG. 15 shows a state in which the multiple data line coupling contact holes 88 and multiple relay electrode coupling contact holes 89 are formed. After the P-channel scan lines 32 are formed, the fifth interlayer insulating layer 95 is formed on the P-channel scan lines 32. The data line coupling contact holes 88 and the relay electrode coupling contact holes 89 are formed in the fourth interlayer insulating layer 94 and the fifth interlayer insulating layer 95.

The multiple data line coupling contact holes 88 are each formed to be electrically couplable to either the first data line relay electrodes 82a or the second data line relay electrodes 82b.

The multiple relay electrode coupling contact holes 89 are formed to be electrically couplable to either the first pixel relay electrodes 81a or the second pixel relay electrodes 81b.

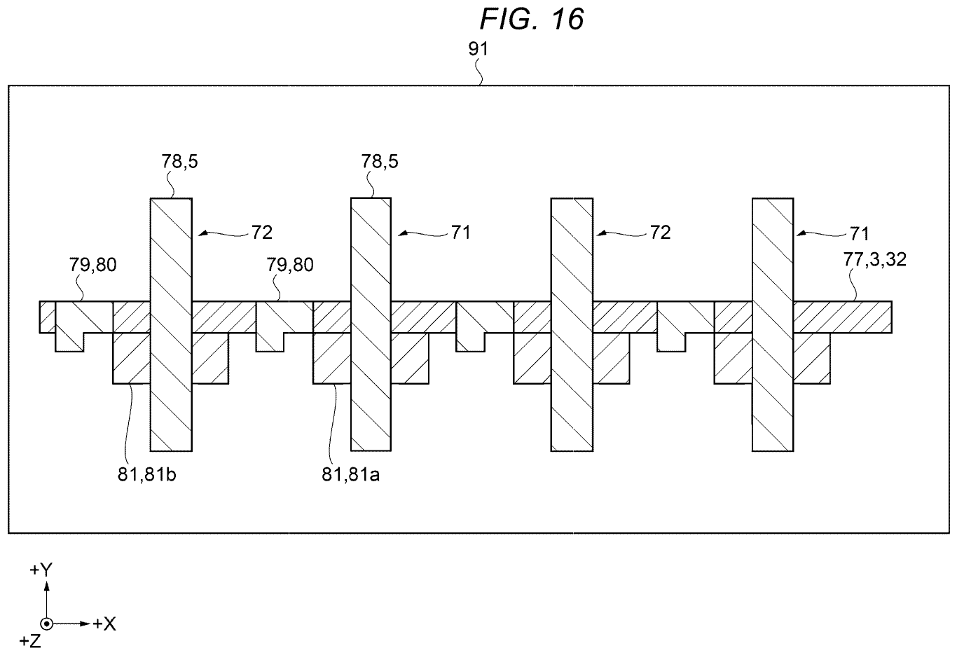

FIG. 16 shows a state in which the electrically conductive layers 78 and third relay layers 79 are formed. The electrically conductive layers 78 and the third relay layers 79 are formed on the fifth interlayer insulating layer 95. The electrically conductive layers 78 extend along the Y direction. The third relay layers 79 are each formed in the form of an island. The electrically conductive layers 78 include the data lines 5. The third relay layers 79 include the relay electrodes 80.

The data lines 5 are formed on the first semiconductor layers 71 and the second semiconductor layers 72. The data lines 5 are formed on the data line coupling contact holes 88. The data lines 5 are formed to be electrically couplable to the data line coupling contact holes 88. The data lines 5 are electrically coupled to the data line relay electrodes 82 via the data line coupling contact holes 88.

The relay electrodes 80 are formed on the pixel relay electrodes 81. The relay electrodes 80 are formed on the relay electrode coupling contact holes 89. The relay electrodes 80 are formed to be electrically couplable to the relay electrode coupling contact holes 89. The relay electrodes 80 are electrically coupled to the pixel relay electrodes 81 via the relay electrode coupling contact holes 89.

### Second Embodiment

In the second embodiment, the configuration of a second element substrate 10b is shown. The second element substrate 10b is an example of the element substrate 10. In the second element substrate 10b, the pixel relay electrodes 81 and the data line relay electrodes 82 are disposed between the N-channel scan lines 31 and the P-channel scan lines 32. The second element substrate 10b includes capacitance lines 7.

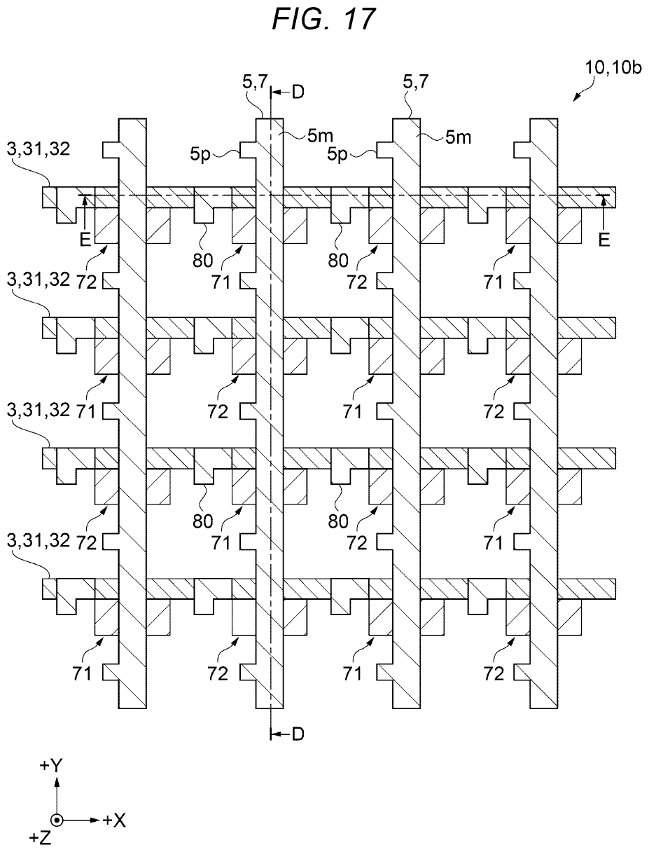

FIG. 17 shows a schematic configuration of the second element substrate 10b. FIG. 17 shows a portion of the second element substrate 10b in the display region A1 in the plan view viewed in the +Z direction. FIG. 17 shows the scan lines 3, the data lines 5, the capacitance lines 7, and the relay electrodes 80. The capacitance lines 7, the first semiconductor layers 71, and the second semiconductor layers 72 are disposed at positions shifted from the data lines 5 in the −Z direction. The scan lines 3 and the relay electrodes 80 shown in FIG. 17 have the same configuration as the scan lines 3 and the relay electrodes 80 shown in FIG. 4. FIG. 17 shows a D-D line and an E-E line. The line D-D and the line E-E are imaginary lines.

The data lines 5 each include a data line body 5m and data line protrusions 5p. The data line body 5m extends along the Y direction. The data line protrusions 5p are provided at positions where the data line protrusions 5p do not overlap with the data line body 5m in the plan view viewed in the +Z direction. The data line protrusions 5p shown in FIG. 17 protrude from the data line body 5m in the −X direction, but not necessarily. The data line protrusions 5p may protrude from the data line body 5m in the +X direction.

The capacitance lines 7 are electrically coupled to the capacitance elements 16 shown in FIG. 3. The capacitance lines 7 shown in FIG. 17 extend along the Y direction. The capacitance lines 7 may extend along the X direction. Constant potential such as common electrode potential or ground potential applied to the common electrode 22 is supplied to the capacitance lines 7 via one of the external coupling terminals 105. The capacitance lines 7 correspond to an example of constant potential wiring.

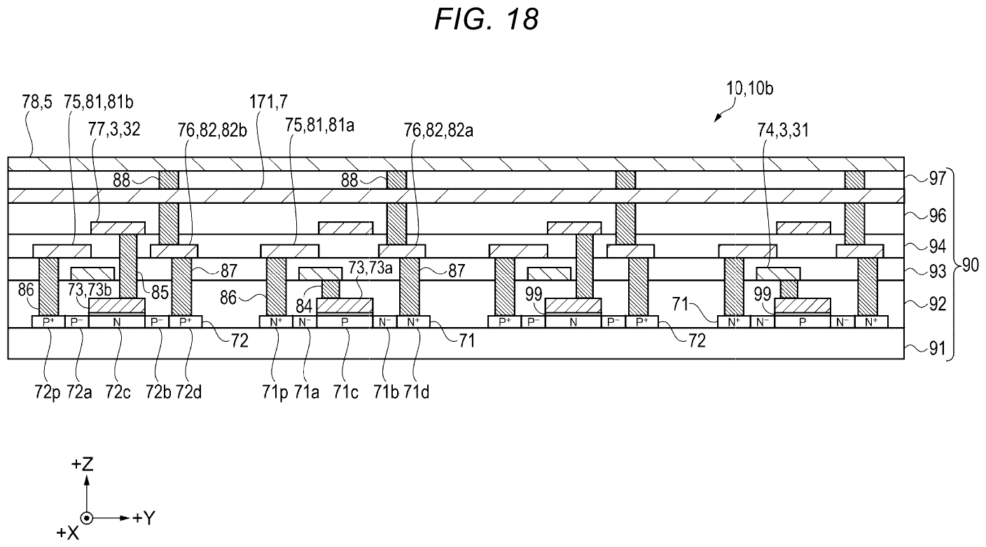

FIG. 18 shows a schematic configuration of the second element substrate 10b. FIG. 18 shows a YZ cross section containing the line D-D shown in FIG. 17. FIG. 18 shows a portion of the second element substrate 10b in the display region A1 in a cross-sectional view viewed in the +X direction. FIG. 18 shows the first semiconductor layers 71, the second semiconductor layers 72, the first gate electrodes 73a, the second gate electrodes 73b, the first light blocking layers 74, the first relay layers 75, the second relay layers 76, the second light blocking layers 77, the electrically conductive layers 78, capacitance electrode layers 171, the first gate coupling contact holes 84, the second gate coupling contact holes 85, the first contact holes 86, the second contact holes 87, the data line coupling contact holes 88, and the insulating layer group 90.

FIG. 18 shows the data line coupling contact holes 88 to clearly show the arrangement thereof, but the first gate coupling contact holes 84 and the like, and the data line coupling contact holes 88 are not disposed in the same cross section.

The configuration of the second element substrate 10b shown in FIG. 8 is the same as the configuration of the first element substrate 10a shown in FIG. 7 except for the capacitance electrode layers 171, the electrically conductive layers 78, and the insulating layer group 90. The insulating layer group 90 of the second element substrate 10b includes the first interlayer insulating layer 91, the second interlayer insulating layer 92, the third interlayer insulating layer 93, the fourth interlayer insulating layer 94, a sixth interlayer insulating layer 96, a seventh interlayer insulating layer 97, and the gate insulating layers 99. The sixth interlayer insulating layer 96 and the seventh interlayer insulating layer 97 are provided in place of the fifth interlayer insulating layer 95 contained in the insulating layer group 90 of the first element substrate 10a.

The sixth interlayer insulating layer 96 is provided on the fourth interlayer insulating layer 94 and the second light blocking layers 77. The sixth interlayer insulating layer 96 is light transmissive, insulating layer. The sixth interlayer insulating layer 96 is made, for example, of an inorganic material such as silicon oxide.

The capacitance electrode layers 171 are disposed on the sixth interlayer insulating layer 96. The capacitance electrode layers 171 are provided between the P-channel scan lines 32 and the data lines 5 along the Z direction. The capacitance electrode layers 171 shown in FIG. 18 are each a thin film extending along the Y direction. The capacitance electrode layers 171 are made of a light blocking, electrically conductive material. Examples of the electrically conductive material that forms the capacitance electrode layers 171 include metal such as tungsten, titanium, chromium, iron, and aluminum, metal nitride, and metal silicide. The capacitance electrode layers 171 include the capacitance lines 7. The capacitance lines 7 are disposed in the capacitance electrode layers 171. The capacitance electrode layers 171 correspond to an example of a fourth layer.

The capacitance lines 7, to which constant potential is applied, are disposed between the P-channel scan lines 32 and the data lines 5 along the Z direction. Since the capacitance lines 7 are disposed between the P-channel scan lines 32 and the data lines 5, parasitic capacitance produced between the P-channel scan lines 32 and the data lines 5 decreases. Failure in display operation of the liquid crystal device 100 due to the parasitic capacitance produced between the P-channel scan lines 32 and the data lines 5 decreases.

The seventh interlayer insulating layer 97 is provided on the sixth interlayer insulating layer 96 and the capacitance electrode layers 171. The seventh interlayer insulating layer 97 is light transmissive, insulating layer. The seventh interlayer insulating layer 97 is made, for example, of an inorganic material such as silicon oxide.

The electrically conductive layers 78 are disposed on the seventh interlayer insulating layer 97. The electrically conductive layers 78 are provided on the side opposite the pixel relay electrodes 81 with the P-channel scan lines 32 interposed therebetween. The electrically conductive layers 78 correspond to an example of a third layer. The electrically conductive layers 78 shown in FIG. 18 are each a thin film extending along the Y direction. The electrically conductive layers 78 are made of a light blocking, electrically conductive material. Examples of the electrically conductive material that forms the electrically conductive layers 78 include metal such as tungsten, titanium, chromium, iron, and aluminum, metal nitride, and metal silicide. The electrically conductive layers 78 include the data lines 5. The data lines 5 are disposed in the electrically conductive layers 78 and electrically coupled to either the first data-line-side source-drain regions 71d or the second data-line-side source-drain regions 72d via the data line relay electrodes 82.

The liquid crystal device 100 preferably includes the data lines 5 disposed in the electrically conductive layers 78 on the side opposite the first pixel relay electrodes 81a with the P-channel scan lines 32 interposed therebetween, and the capacitance lines 7 disposed in the capacitance electrode layers 171 between the P-channel scan lines 32 and the data lines 5.

The capacitance lines 7 are provided between the P-channel scan lines 32 and the data lines 5, so that the parasitic capacitance produced between the P-channel scan lines 32 and the data lines 5 decreases. Failure in display operation of the liquid crystal device 100 due to the parasitic capacitance produced between the P-channel scan lines 32 and the data lines 5 decreases.

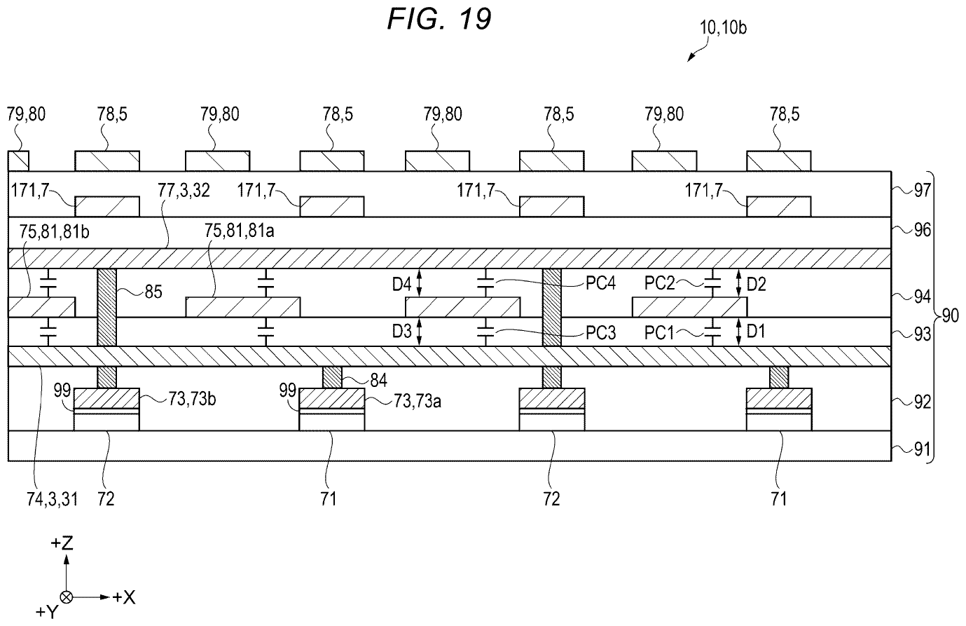

FIG. 19 shows a schematic configuration of the second element substrate 10b. FIG. 19 shows an XZ cross section containing the line E-E shown in FIG. 17. FIG. 19 shows a portion of the second element substrate 10b in the display region A1 in a cross-sectional view viewed in the −Y direction. FIG. 19 shows the first semiconductor layers 71, the second semiconductor layers 72, the gate electrodes 73, the first light blocking layers 74, the first relay layers 75, the second light blocking layers 77, the capacitance electrode layers 171, the electrically conductive layers 78, the relay electrodes 80, the pixel relay electrodes 81, the first gate coupling contact holes 84, the second gate coupling contact holes 85, and the insulating layer group 90.

FIG. 19 shows the first gate coupling contact holes 84 and the second gate coupling contact holes 85 to clearly show the arrangement thereof, but the first gate coupling contact holes 84 and the second gate coupling contact holes 85 are not disposed in the same cross section.

The configuration of the second element substrate 10b shown in FIG. 19 is the same as the configuration of the first element substrate 10a shown in FIG. 8 except for the capacitance electrode layers 171, the electrically conductive layers 78, and the insulating layer group 90. The insulating layer group 90 of the second element substrate 10b includes the first interlayer insulating layer 91, the second interlayer insulating layer 92, the third interlayer insulating layer 93, the fourth interlayer insulating layer 94, the sixth interlayer insulating layer 96, the seventh interlayer insulating layer 97, and the gate insulating layers 99. The sixth interlayer insulating layer 96 and the seventh interlayer insulating layer 97 are provided in place of the fifth interlayer insulating layer 95 contained in the insulating layer group 90 of the first element substrate 10a.

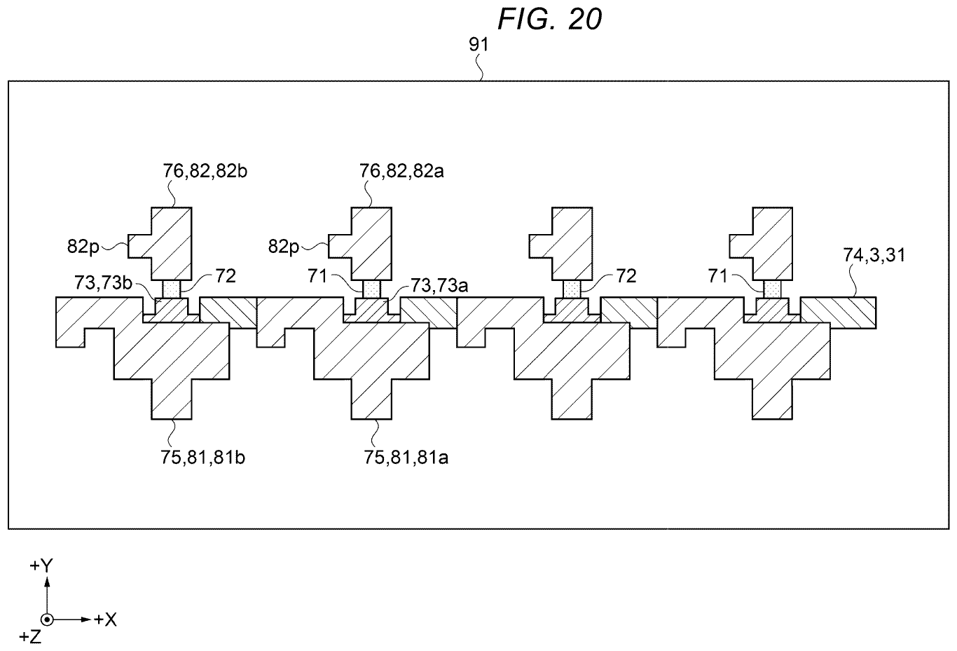

FIGS. 20 to 25 show the process of creating the second element substrate 10b. FIGS. 20 to 25 show a creation process from the formation of the pixel relay electrodes 81 and the data line relay electrodes 82 to the formation of the data lines 5. The creation process before creating the pixel relay electrodes 81 and the data line relay electrodes 82 is the same as the process of creating the first element substrate 10a shown in FIGS. 9, 10, and 11. FIGS. 20 to 25 show a portion of the second element substrate 10b in the display region A1 in the plan view viewed in the +Z direction.

FIG. 20 shows a state in which the first relay layers 75 and the second relay layers 76 are formed. The first relay layers 75 and the second relay layers 76 are formed on the third interlayer insulating layer 93 after the first contact holes 86 and the second contact holes 87 shown in FIG. 11 are formed. The first relay layers 75 and the second relay layers 76 are formed with portions of the gate electrodes 73 exposed in the plan view viewed in the +Z direction. The first relay layers 75 include the multiple pixel relay electrodes 81. The second relay layers 76 include the multiple data line relay electrodes 82.

The multiple pixel relay electrodes 81 include the first pixel relay electrodes 81a and the second pixel relay electrodes 81b. The first pixel relay electrodes 81a are formed on the first pixel-electrode-side source-drain regions 71p of the first semiconductor layers 71 and the N-channel scan lines 31. The first pixel relay electrodes 81a are formed on the protrusions 31b and the bodies 31a of the N-channel scan lines 31. The second pixel relay electrodes 81b are formed on the second pixel-electrode-side source-drain regions 72p of the second semiconductor layers 72 and the N-channel scan lines 31. The second pixel relay electrodes 81b are formed on the protrusions 31b and the bodies 31a of the N-channel scan lines 31.

The multiple pixel relay electrodes 81 each include one of the first pixel relay electrode 81a and the second pixel relay electrode 81b. The first pixel relay electrodes 81a are formed on the first pixel-electrode-side source-drain regions 71p of the first semiconductor layers 71 and the N-channel scan lines 31. The first pixel relay electrodes 81a are formed on the protrusions 31b and the bodies 31a of the N-channel scan lines 31. The second pixel relay electrodes 81b are formed on the second pixel-electrode-side source-drain regions 72p of the second semiconductor layers 72 and the N-channel scan lines 31. The second pixel relay electrodes 81b are formed on the protrusions 31b and the bodies 31a of the N-channel scan lines 31.

The multiple data line relay electrodes 82 include the first data line relay electrodes 82a and the second data line relay electrodes 82b. The first data line relay electrodes 82a are formed on the first data-line-side source-drain regions 71d of the first semiconductor layers 71. The second data line relay electrodes 82b are formed on the second data-line-side source-drain regions 72d of the second semiconductor layers 72.

The first data line relay electrode 82a and the second data line relay electrode 82b each have a data line relay electrode protrusion 82p. The data line relay electrode protrusions 82p shown in FIG. 20 extend in the −X direction. The data line relay electrode protrusions 82p extend in the same direction as the data line protrusions 5p.

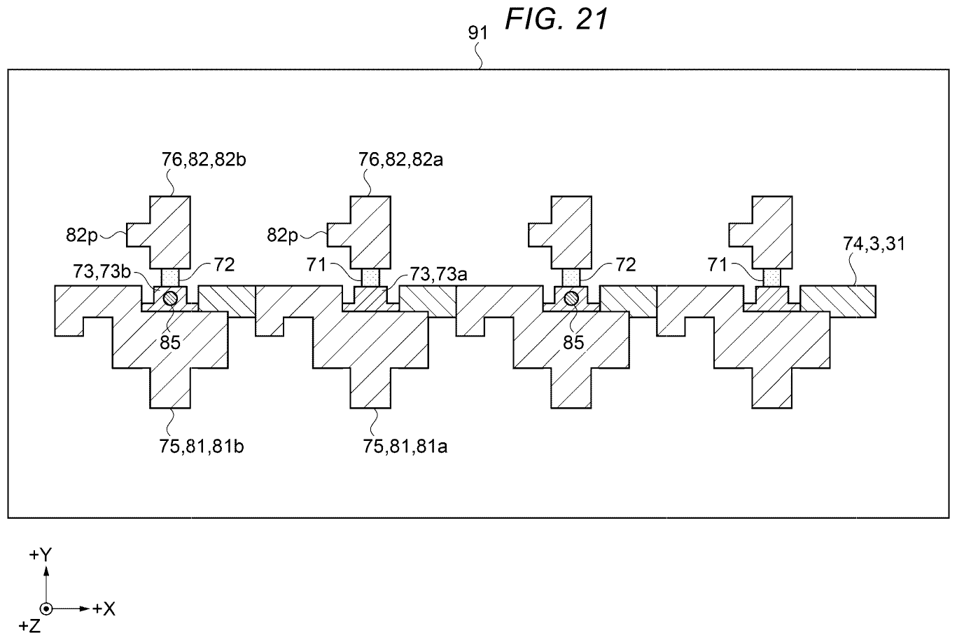

FIG. 21 shows a state in which the second gate coupling contact holes 85 are formed. After the first relay layers 75 and the second relay layers 76 are formed, the fourth interlayer insulating layer 94 is formed on the first relay layers 75 and the second relay layers 76. The second gate coupling contact holes 85 are formed in the second interlayer insulating layer 92, the third interlayer insulating layer 93, and the fourth interlayer insulating layer 94.

The second gate coupling contact holes 85 are formed so as to be electrically couplable to the second gate electrodes 73b on the second semiconductor layers 72. The second gate coupling contact holes 85 are formed at positions shifted in the +Y direction from the first gate coupling contact holes 84.

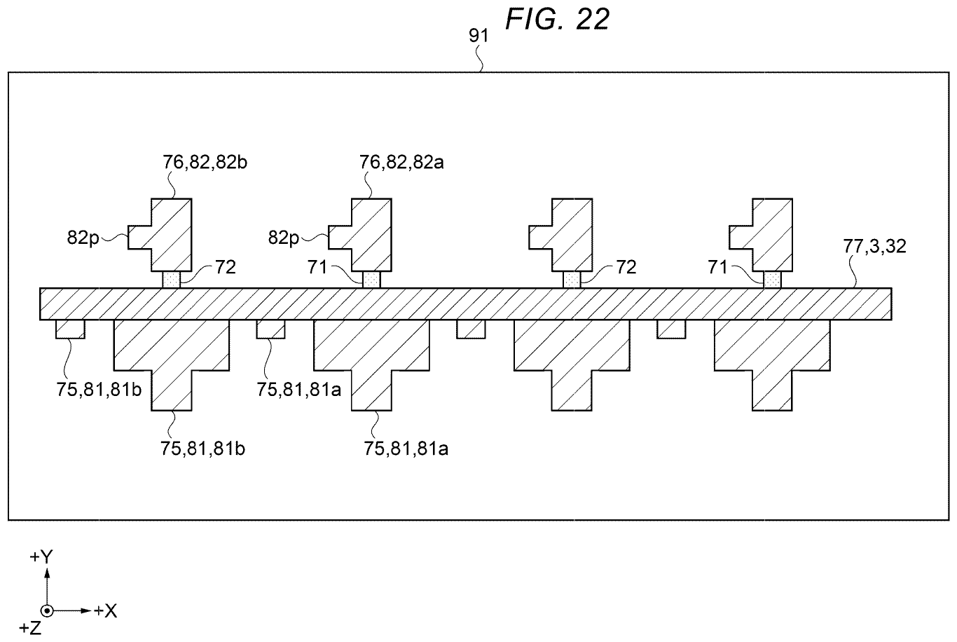

FIG. 22 shows a state in which the second light blocking layers 77 are formed. The second light blocking layers 77 are formed on the fourth interlayer insulating layer 94. The second light blocking layers 77 extend along the X direction. The second light blocking layers 77 include the P-channel scan lines 32. After the second light blocking layers 77 are formed, the sixth interlayer insulating layer 96 is formed on the second light blocking layer 77 and the fourth interlayer insulating layer 94.

The P-channel scan lines 32 are formed on the bodies 31a of the N-channel scan lines 31 and the gate electrodes 73. The P-channel scan lines 32 are formed on the second gate coupling contact holes 85. The P-channel scan lines 32 are formed to be electrically couplable to the second gate coupling contact holes 85. The P-channel scan lines 32 are electrically coupled to the second gate electrodes 73b via the second gate coupling contact holes 85.

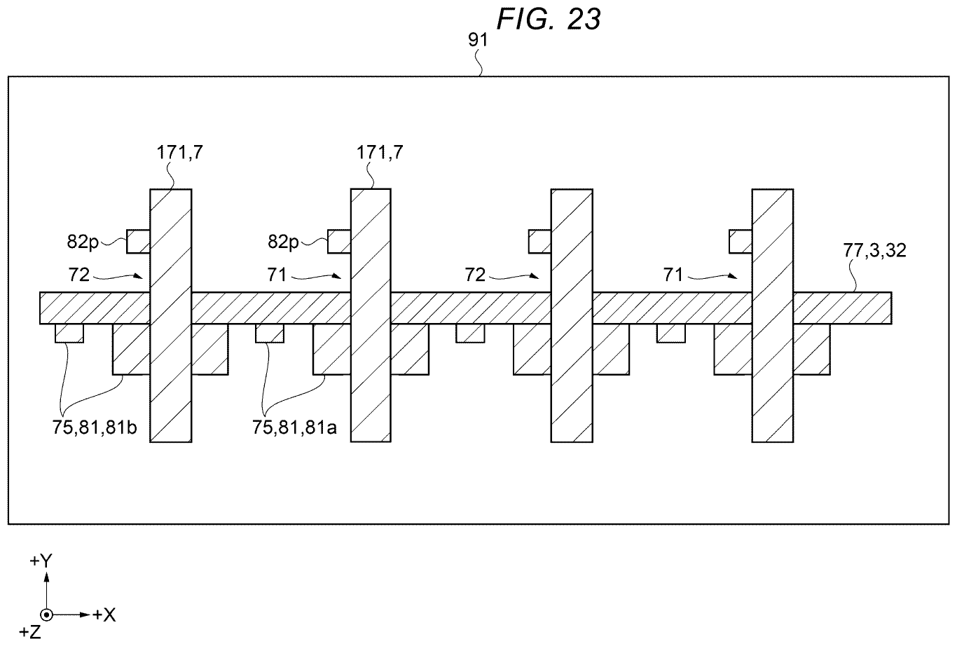

FIG. 23 shows a state in which the capacitance electrode layers 171 are formed. The capacitance electrode layers 171 are formed on the sixth interlayer insulating layer 96. The capacitance electrode layers 171 extend along the Y direction. The capacitance electrode layers 171 are formed at positions where the data line relay electrode protrusions 82p are exposed in the plan view viewed in the +Z direction. The capacitance electrode layers 171 include the capacitance lines 7.

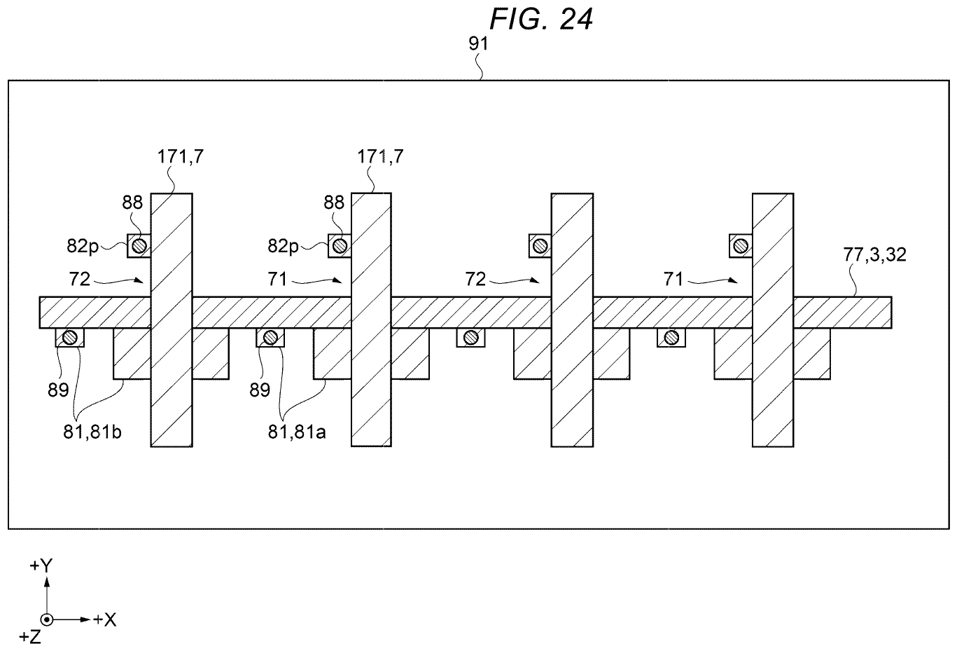

FIG. 24 shows a state in which the multiple data line coupling contact holes 88 and the multiple relay electrode coupling contact holes 89 are formed. After the capacitance electrode layers 171 are formed, the seventh interlayer insulating layer 97 is formed on the sixth interlayer insulating layer 96 and the capacitance electrode layers 171. The data line coupling contact holes 88 and the relay electrode coupling contact holes 89 are formed in the fourth interlayer insulating layer 94, the sixth interlayer insulating layer 96, and the seventh interlayer insulating layer 97.

The multiple data line coupling contact holes 88 are formed to be electrically couplable to either the data line relay electrode protrusions 82p of the first data line relay electrodes 82a or the data line relay electrode protrusions 82p of the second data line relay electrodes 82b.

The multiple relay electrode coupling contact holes 89 are formed to be electrically couplable to either the first pixel relay electrodes 81a or the second pixel relay electrodes 81b.

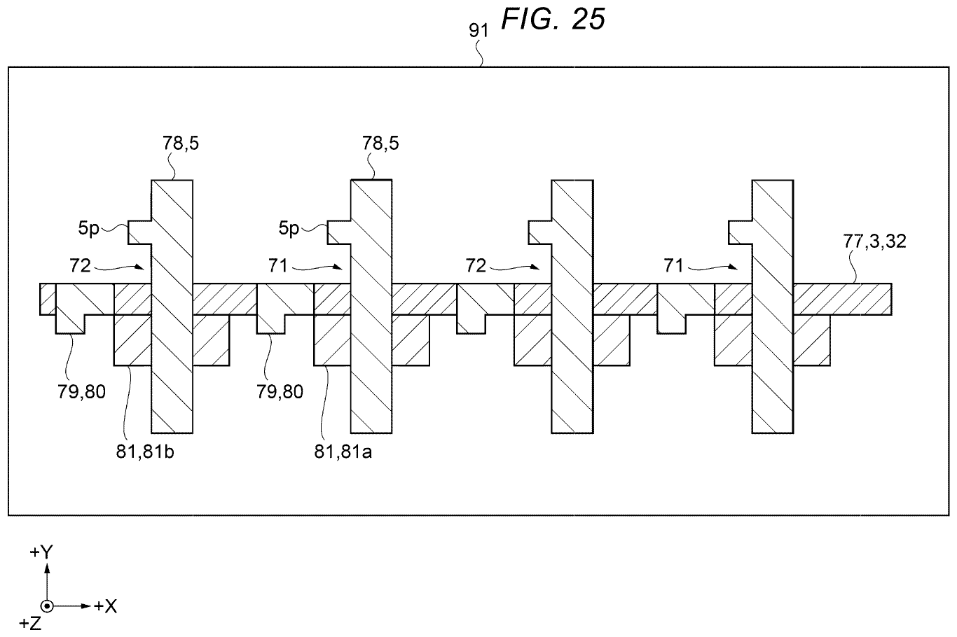

FIG. 25 shows a state in which the electrically conductive layers 78 and the third relay layers 79 are formed. The electrically conductive layers 78 and the third relay layers 79 are formed on the seventh interlayer insulating layer 97. The electrically conductive layers 78 are formed on the capacitance electrode layers 171. The electrically conductive layers 78 extend along the Y direction. The third relay layers 79 are each formed in the form of an island. The electrically conductive layers 78 include the data lines 5. The third relay layers 79 include the relay electrodes 80.

The data lines 5 are formed on the first semiconductor layers 71 and the second semiconductor layers 72. The data line bodies 5m of the data lines 5 are formed on the capacitance lines 7. The data line protrusions 5p of the data lines 5 are formed on either the data line relay electrode protrusions 82p of the first data line relay electrodes 82a or the data line relay electrode protrusions 82p of the second data line relay electrodes 82b. The data line protrusions 5p of the data lines 5 are formed to be electrically couplable to the data line coupling contact holes 88. The data lines 5 are electrically coupled to the data line relay electrodes 82 via the data line coupling contact holes 88.

The relay electrodes 80 are formed on the pixel relay electrodes 81. The relay electrodes 80 are formed on the relay electrode coupling contact holes 89. The relay electrodes 80 are formed to be electrically couplable to the relay electrode coupling contact holes 89. The relay electrodes 80 are electrically coupled to the pixel relay electrodes 81 via the relay electrode coupling contact holes 89.

The first element substrate 10a shown in the first embodiment and the second element substrate 10b shown in the second embodiment each include the N-channel scan lines 31 in the first light blocking layers 74 and the P-channel scan lines 32 in the second light blocking layers 77, but not necessarily. The element substrate 10 may have a configuration in which the first light blocking layers 74 include the P-channel scan lines 32 and the second light blocking layers 77 include the N-channel scan lines 31.

The first and second embodiments show the suppression of the fluctuation of the potential applied to the pixel relay electrodes 81 by the gate signals applied to the N-channel scan lines 31 and the gate signals applied to the P-channel scan lines 32, but not necessarily. The effect of suppressing the potential fluctuation in the data line relay electrodes 82 can be provided by the gate signals applied to the N-channel scan lines 31 and the gate signals applied to the P-channel scan lines 32.

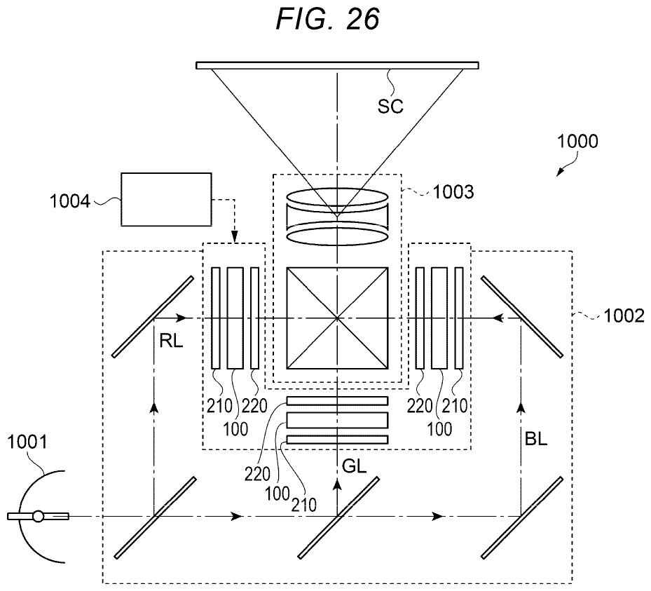

FIG. 26 shows a schematic configuration of a projection-type display apparatus 1000. The projection-type display apparatus 1000 corresponds to an example of an electronic instrument. The projection-type display apparatus 1000 is, for example, a three-plate projector including three liquid crystal devices 100. The projection-type display apparatus 1000 includes an illuminator 1001, an illumination system 1002, a projection system 1003, and a control unit 1004.

The illuminator 1001 is a light source that outputs light to the illumination system 1002. The illuminator 1001 includes a lamp light source such as a halogen lamp, a xenon lamp, or an ultra-high pressure mercury lamp. The illuminator 1001 may include a solid-state light source such as a light emitting diode (LED) or a laser light source.

The illumination system 1002 separates the light output from the illuminator 1001 into red light RL, green light GL, and blue light BL. The illumination system 1002 supplies the red light RL, the green light GL, and the blue light BL to the liquid crystal devices 100 provided in correspondence with the three types of color light.

The liquid crystal devices 100 modulate the three types of light supplied from the illumination system 1002. The liquid crystal devices 100 are each either the liquid crystal device 100 including the first element substrate 10a or the liquid crystal device 100 including the second element substrate 10b. The three liquid crystal devices 100 each function as a light modulator that modulates any one of the three types of separated light, the red light RL, the green light GL, and the blue light BL, in accordance with an image to be displayed. A first polarizer 210 is disposed on the light incident side of each of the liquid crystal devices 100. A second polarizer 220 is disposed on the light exiting side of each of liquid crystal devices 100. The first polarizer 210 and the second polarizer 220 disposed at each of the liquid crystal devices 100 are provided in a cross-Nicol arrangement in which the light transmission axes of the polarizers through which light passes are perpendicular to each other. The liquid crystal devices 100 output the light to the projection system 1003 via the second polarizers 220.

The projection system 1003 combines the red light RL, the green light GL, and the blue light BL modulated by the liquid crystal devices 100 with one another to form image light. The projection system 1003 projects the image light onto a screen SC.

The control unit 1004 is a controller that controls each portion of the projection-type display apparatus 1000. The control unit 1004 is, for example, a processor including a central processing unit (CPU). The control unit 1004 includes one or more processors. The control unit 1004 may include semiconductor memories such as a read only memory (ROM) and a random access memory (RAM). The semiconductor memories function as a work area of the control unit 1004. The control unit 1004 controls the liquid crystal devices 100 to modulate the red light RL, the green light GL, and the blue light BL supplied from the illumination system 1002 in accordance with an image to be displayed.

The projection-type display apparatus 1000 is not limited to a three-plate projector. The projection-type display apparatus 1000 may be a projector including one, two, or four or more liquid crystal devices 100. An apparatus including the liquid crystal device 100 may be a smartphone, a personal digital assistant (PDA), a camera, a television, a car navigation system, a personal computer, a display, electronic paper, an electronic calculator, a video phone, a point of sale (POS) system, a printer, a scanner, a copier, a video player, an instrument including a touch panel, or the like. An apparatus including the liquid crystal device 100 corresponds to an example of the electronic instrument.

The projection-type display apparatus 1000 includes either the liquid crystal device 100 including the first element substrate 10a or the liquid crystal device 100 including the second element substrate 10b.

Disposing the pixel relay electrodes 81 between the N-channel scan lines 31 and the P-channel scan lines 32 reduces the fluctuation of the potential applied to the pixel electrodes 15 due to the parasitic capacitance. A projection-type display apparatus 1000 capable of suppressing failure in display operation of the liquid crystal device 100 due to the potential fluctuation can be provided.

What is claimed is:

1. An electro-optical device, comprising:
a first transistor of a first electrical conductivity type;
a second transistor of a second electrical conductivity type;
a first source-drain electrode electrically coupled to a first source-drain region of the first transistor;
a second source-drain electrode electrically coupled to a second source-drain region of the second transistor;
a first scan line disposed in a first layer between the first transistor and the first source-drain electrode, and electrically coupled to a first gate electrode of the first transistor; and
a second scan line disposed in a second layer on a side opposite the second transistor with the second source-drain electrode interposed therebetween, and electrically coupled to a second gate electrode of the second transistor.

2. The electro-optical device according to claim 1, further comprising:
a data line disposed in a third layer on a side opposite the first source-drain electrode with the second scan line interposed therebetween, and
constant potential wiring disposed in a fourth layer between the second scan line and the data line.

3. The electro-optical device according to claim 1, wherein
the first transistor and the second transistor are disposed adjacent to each other in a plan view.

4. The electro-optical device according to claim 1, wherein
a first area of a first region in which the first source-drain electrode and the first scan line overlap with each other in a plan view is greater than a second area of a second region in which the first source-drain electrode and the second scan line overlap with each other in the plan view,
a third area of a third region in which the second source-drain electrode and the first scan line overlap with each other in the plan view is greater than a fourth area of a fourth region in which the second source-drain electrode and the second scan line overlap with each other in the plan view,
a first distance between the first source-drain electrode and the first scan line is greater than a second distance between the first source-drain electrode and the second scan line, and
a third distance between the second source-drain electrode and the first scan line is greater than a fourth distance between the second source-drain electrode and the second scan line.

5. The electro-optical device according to claim 1, further comprising:
a first insulating layer disposed in a layer between a group of the first source-drain electrode and the second source-drain electrode, and the second scan line; and
a second insulating layer disposed in a layer between a group of the first source-drain electrode and the second source-drain electrode, and the first scan line, the second insulating layer being made of the same material as the first insulating layer.

6. The electro-optical device according to claim 1, wherein
an LDD region is provided between the first source-drain region and a first channel region of the first transistor, and
the first scan line includes a body extending in a first direction and a protrusion extending from the body along the LDD region in a second direction that intersects with the first direction.

7. The electro-optical device according to claim 2, further comprising
a complementary sampling transistor electrically coupled to the data line.

8. An electronic instrument, comprising the electro-optical device according to claim 1.
